(19) United States
(12) Patent Application Publication
(10) Pub. No.: US 2025/0183596 A1
(43) Pub. Date: Jun. 5, 2025

(54) CONNECTOR, CONNECTOR MODULE, AND ELECTRONIC DEVICE

(71) Applicant: KYOCERA CORPORATION, Kyoto (JP)

(72) Inventors: Masayoshi KAKINO, Yokohama-shi, Kanagawa (JP); Shunsuke MORITA, Yokohama-shi, Kanagawa (JP); Fumihito IKEGAMI, Funabashi-shi, Chiba (JP); Masashi KAKENO, Yokohama-shi, Kanagawa (JP)

(21) Appl. No.: 18/881,256

(22) PCT Filed: Jul. 3, 2023
(86) PCT No.: PCT/JP2023/024692

§ 371 Date: Jan. 3, 2025

(30) Foreign Application Priority Data
Jul. 8, 2022 (JP) 2022-110845

(51) Int. Cl. H01R 13/6585; H01R 12/91

(52) U.S. Cl. CPC H01R 13/6585; H01R 12/91

(57) ABSTRACT

A connector 10 according to the present disclosure includes a frame-shaped first insulator 20; a second insulator 30 located at the first insulator 20, movable relative to the first insulator 20, and configured to be mated with a connection target 70; multiple first contacts 50 attached to the first insulator 20 and the second insulator 30; and a first shield member 60a or first shield members 60a, each being located between the multiple first contacts 50, and each first shield member 60a includes a first shield portion 61a located to be parallel to a first direction intersecting a mating direction in which the connection target 70 and the second insulator 30 are mated with each other.

### CROSS-REFERENCE TO RELATED APPLICATIONS

The present application claims priority from Japanese Patent Application No. 2022-110845 (filed Jul. 8, 2022) the disclosure of which is hereby incorporated by reference herein in its entirety.

### TECHNICAL FIELD

The present disclosure relates to a connector, a connector module, and an electronic device.

### BACKGROUND OF INVENTION

Connectors having a floating structure have been known as a technique to improve the reliability of connection with a connection target. Such a connector absorbs a positional deviation from the connection target by, for example, a movable insulator, which is part of the connector, moving when being mated and also after being mated. Patent Literature 1 discloses a connector in which smooth movement of such a movable insulator is ensured.

### CITATION LIST

### Patent Literature

Patent Literature 1: Japanese Patent No. 5946804

### SUMMARY

In an embodiment of the present disclosure, a connector includes a frame-shaped first insulator, a second insulator, multiple first contacts, and a first shield member or first shield members. The second insulator is located at the first insulator, movable relative to the first insulator, and configured to be mated with a connection target. The multiple first contacts are attached to the first insulator and the second insulator. The first shield member or first shield members are each located between the multiple first contacts. Each first shield member includes a first shield portion located to be parallel to a first direction intersecting a mating direction in which the connection target and the second insulator are mated with each other.

In an embodiment of the present disclosure, a connector module includes the connector described above, and the connection target. The connection target includes a third insulator configured to be mated with the second insulator, multiple second contacts attached to the third insulator, and a third shield member or third shield members attached to the third insulator, each third shield member being located between the multiple second contacts. In a mated state in which the connector and the connection target are mated with each other, each first shield member is in contact with one of the third shield members.

In an embodiment of the present disclosure, an electronic device includes the connector described above or the connector module described above.

### BRIEF DESCRIPTION OF THE DRAWINGS

FIG. 1 is a perspective view of a connector according to an embodiment with a connection target connected to it, illustrating its outer appearance from above.

FIG. 2 is a perspective view of the connector according to an embodiment with the connection target separated from it, illustrating its outer appearance from above.

FIG. 3 is a perspective view of the connector in FIG. 1 alone, illustrating its outer appearance from above.

FIG. 4 is an exploded perspective view of the connector in FIG. 3 from above.

FIG. 5 is a cross-sectional view taken along arrow line V-V in FIG. 3.

FIG. 6 is a perspective view of a pair of contacts in FIG. 4, illustrating its outer appearance from above.

FIG. 7 is a front view of the pair of contacts in FIG. 6.

FIG. 8 is a side view of the pair of contacts in FIG. 6.

FIG. 9 is a perspective view of a pair of contacts according to another example, illustrating its outer appearance from above.

FIG. 10 is a front view of the pair of contacts in FIG. 9.

FIG. 11 is a side view of the pair of contacts in FIG. 9.

FIG. 12 is a perspective view of a set of a pair of contacts and a shield member in

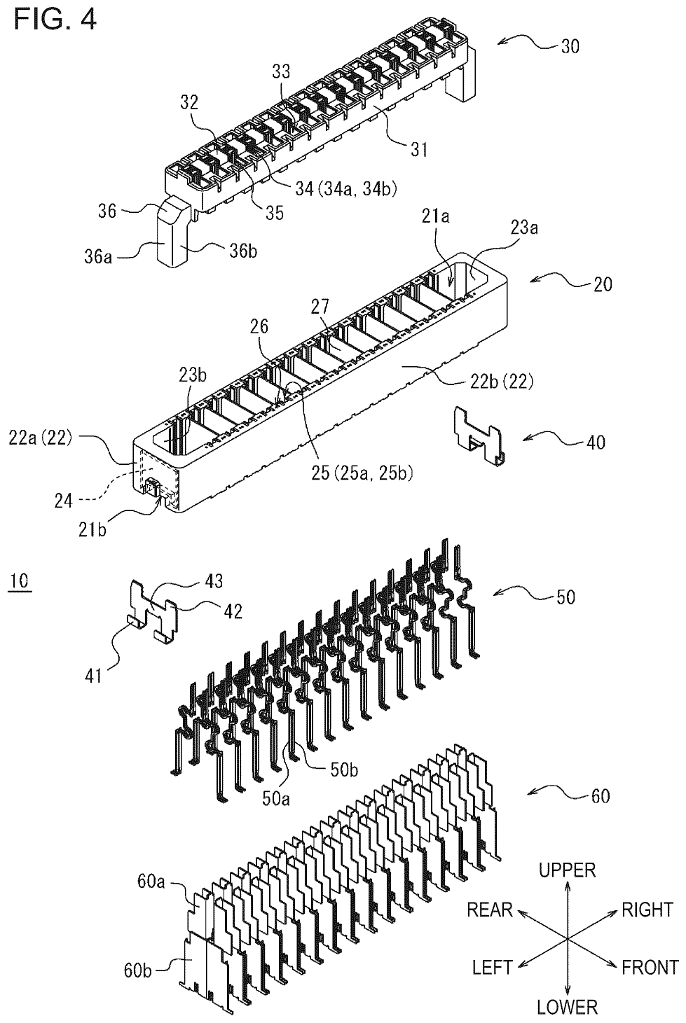

FIG. 4, illustrating their outer appearances from above.

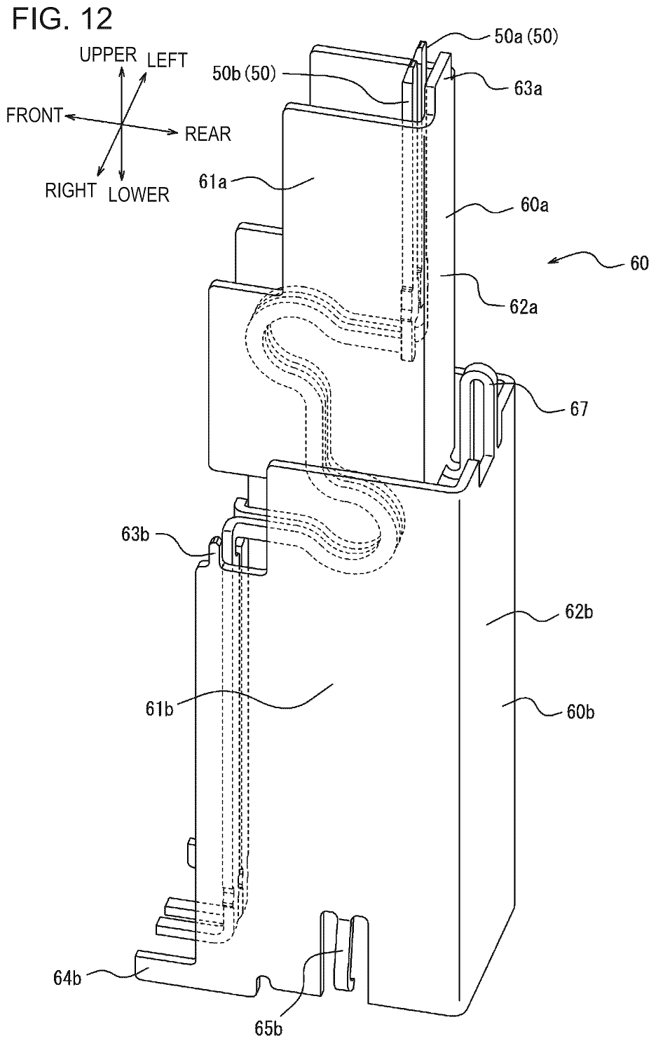

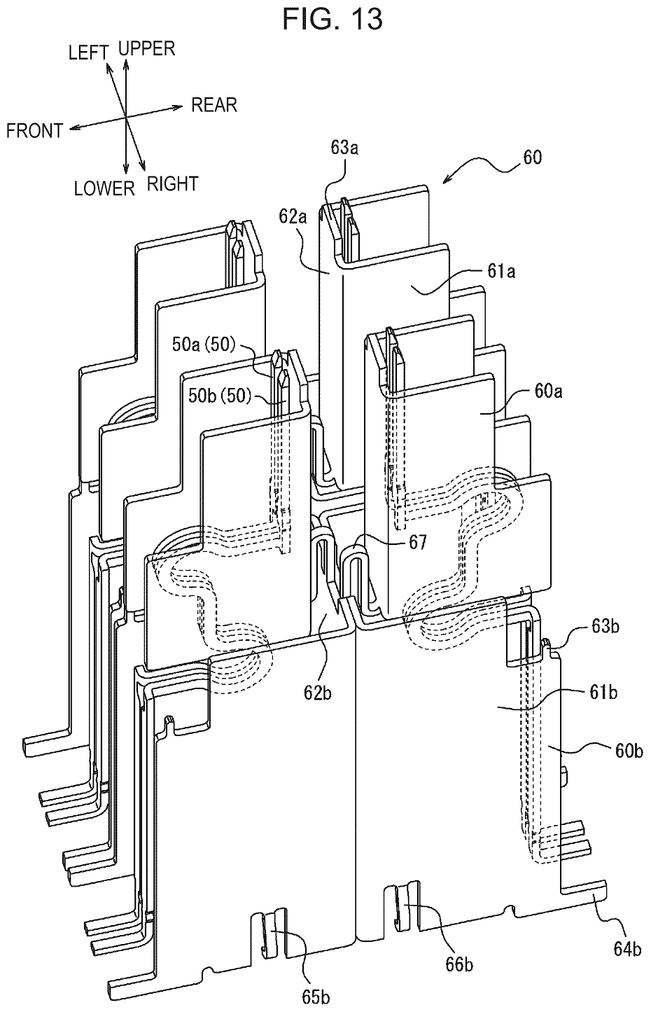

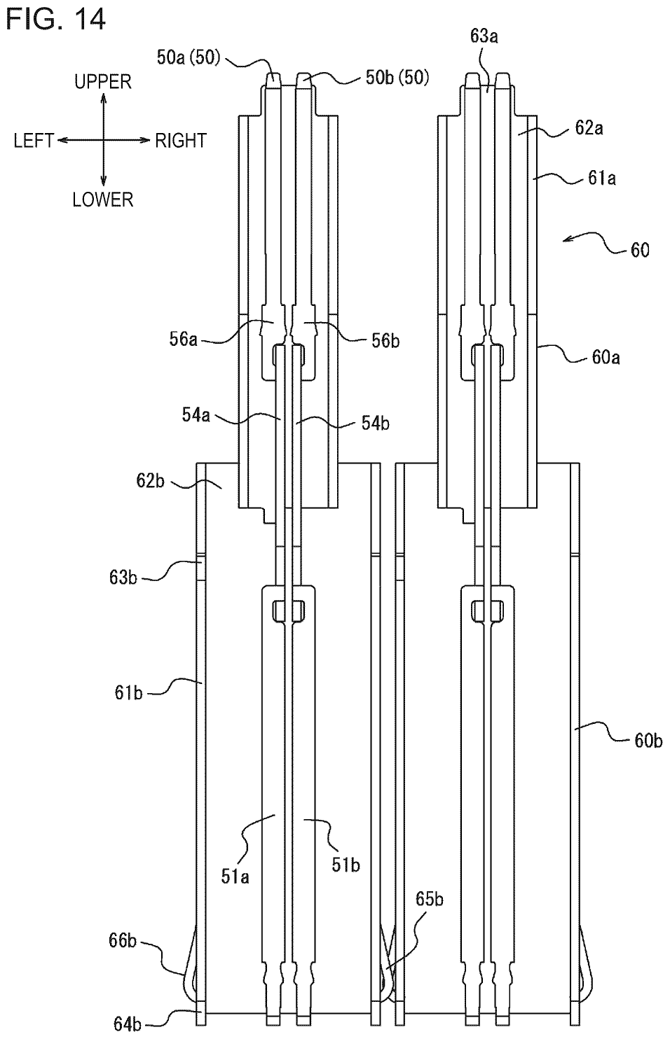

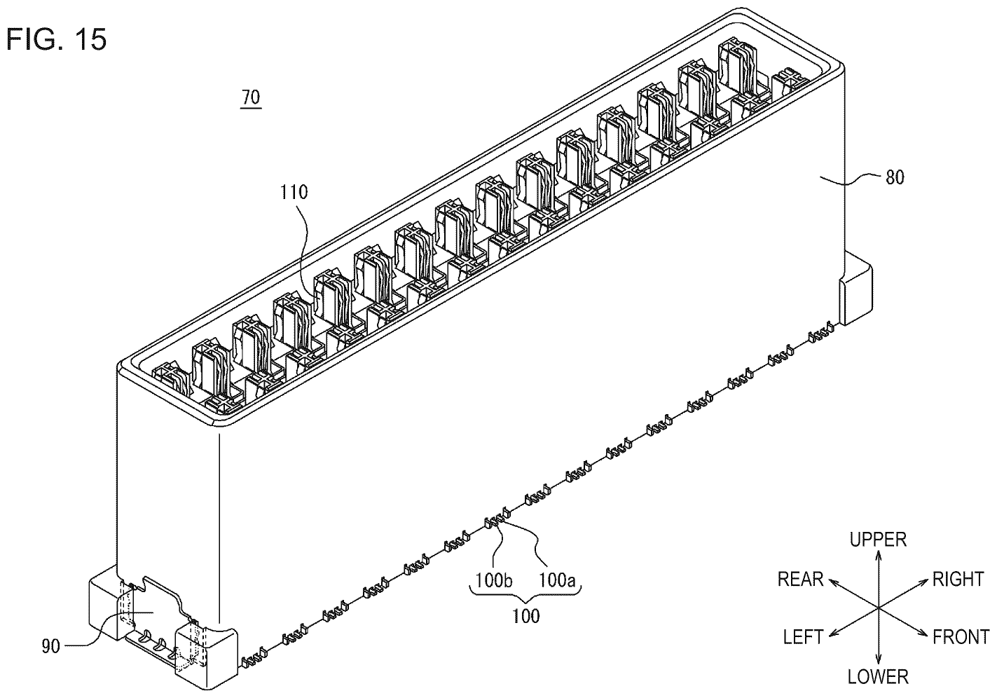

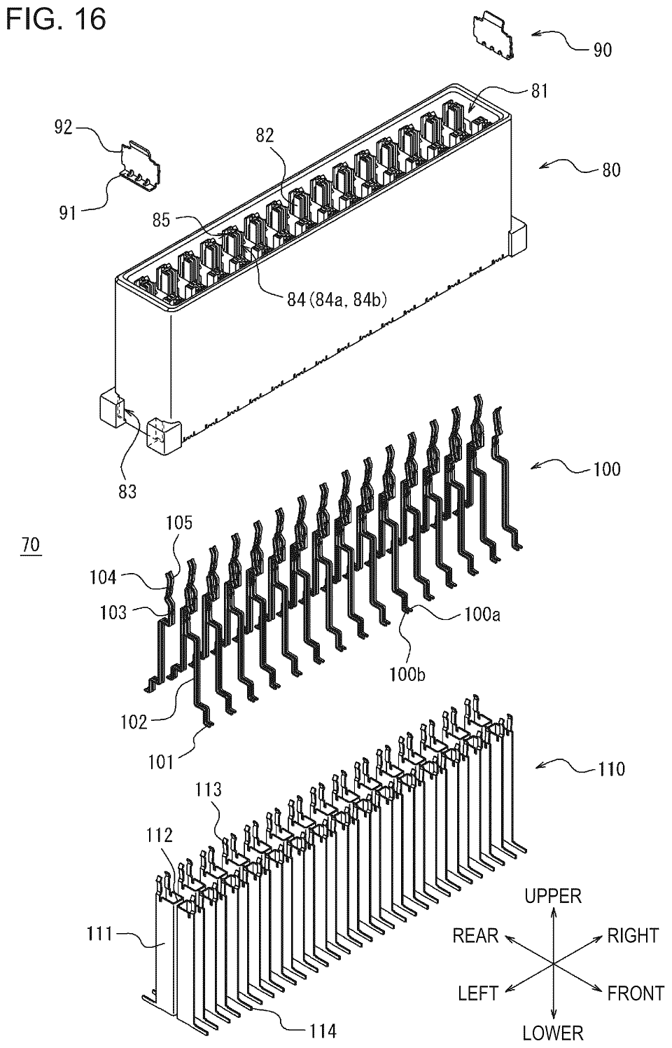

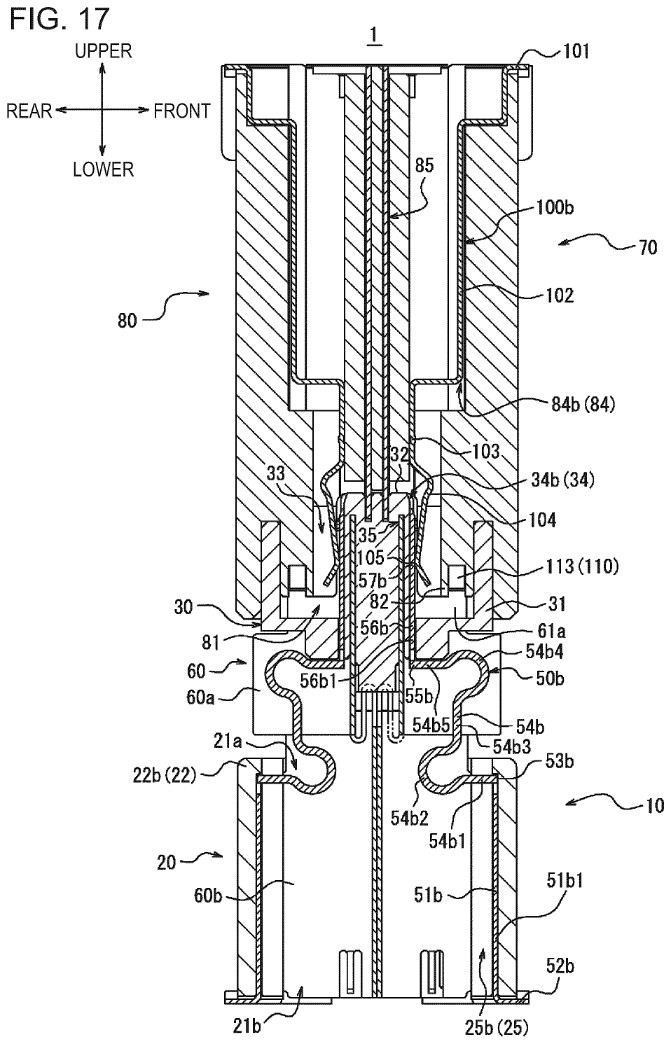

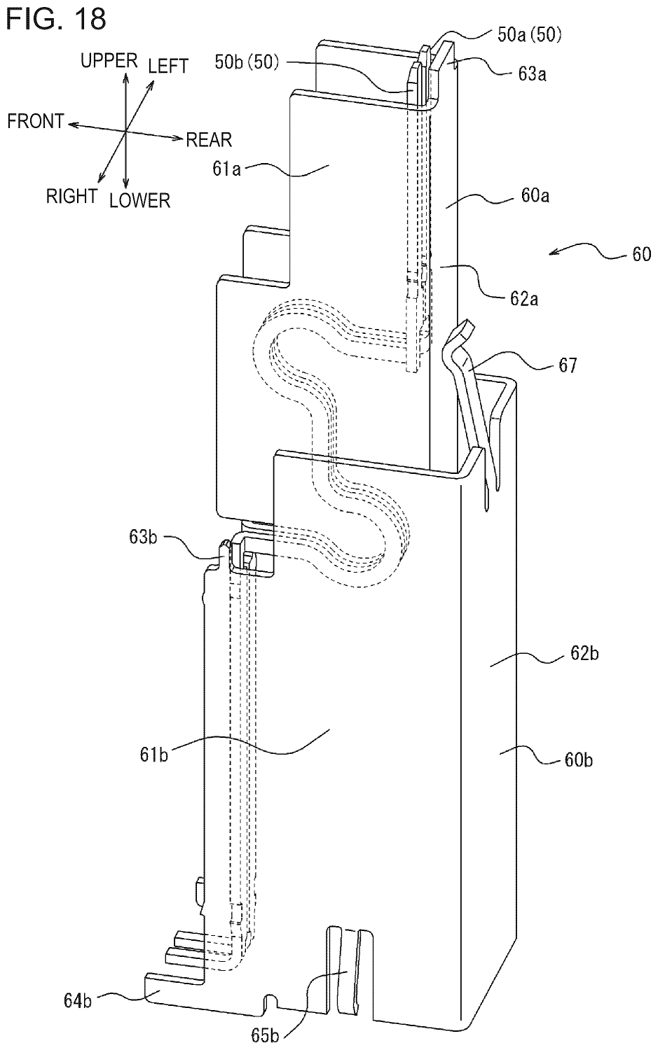

FIG. 13 is a perspective view of four sets of the pair of contacts and the shield member in FIG. 12, illustrating their outer appearances from above.

FIG. 14 is a front view of the pairs of contacts and the shield members in FIG. 13.

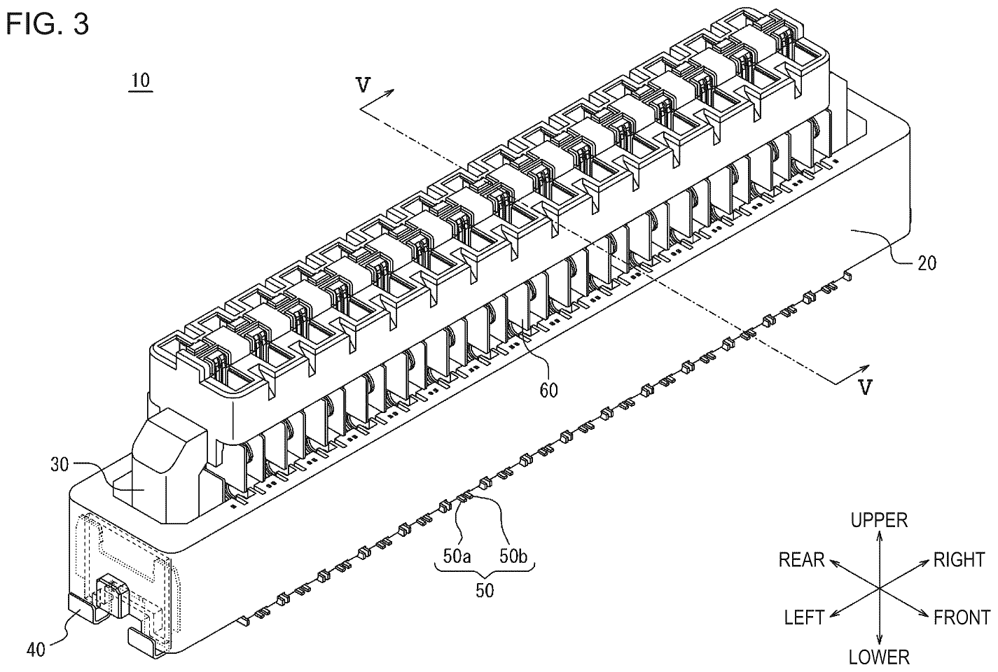

FIG. 15 is a perspective view of a connection target configured to be connected to the connector in FIG. 3, illustrating its outer appearance from above.

FIG. 16 is an exploded perspective view of the connection target in FIG. 15 from above.

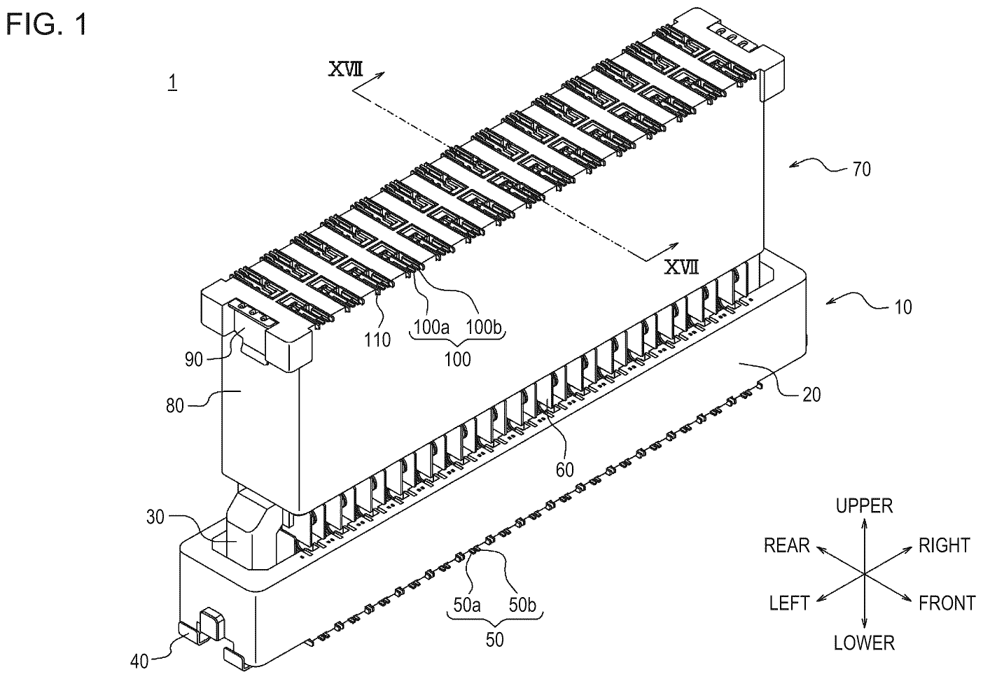

FIG. 17 is a cross-sectional view taken along arrow line XVII-XVII in FIG. 1.

FIG. 18 is a perspective view of a set of a pair of contacts and a shield member of a connector according to a variation, illustrating their outer appearances from above.

### DESCRIPTION OF EMBODIMENTS

In electronic devices, the amount of information and the speed of signal transmission are increasing significantly lately. Connectors including a floating structure are also required to be designed to support such high capacity and high-speed transmission. However, in conventional connectors including, for example, the floating connector described in Patent Literature 1, design to support high-speed transmission, such as a consideration for cross talk between terminals, has not been sufficiently taken into account.

A connector, a connector module, and an electronic device according to an embodiment of the present disclosure are capable of providing favorable transmission characteristics in signal transmission even though they have a floating structure.

Hereinafter, an embodiment of the present disclosure will be described in detail with reference to the accompanying drawings. In the following description, the front-rear direction, the right-left direction, and the up-down direction are based on the arrow directions in the figures. The direction of each arrow is consistent across the different drawings, FIGS. 1 to 14, and 17. The direction of each arrow is consistent between FIGS. 15 and 16. In some drawings, illustration of circuit boards CB1 and CB2 described later is omitted to make illustration simple.

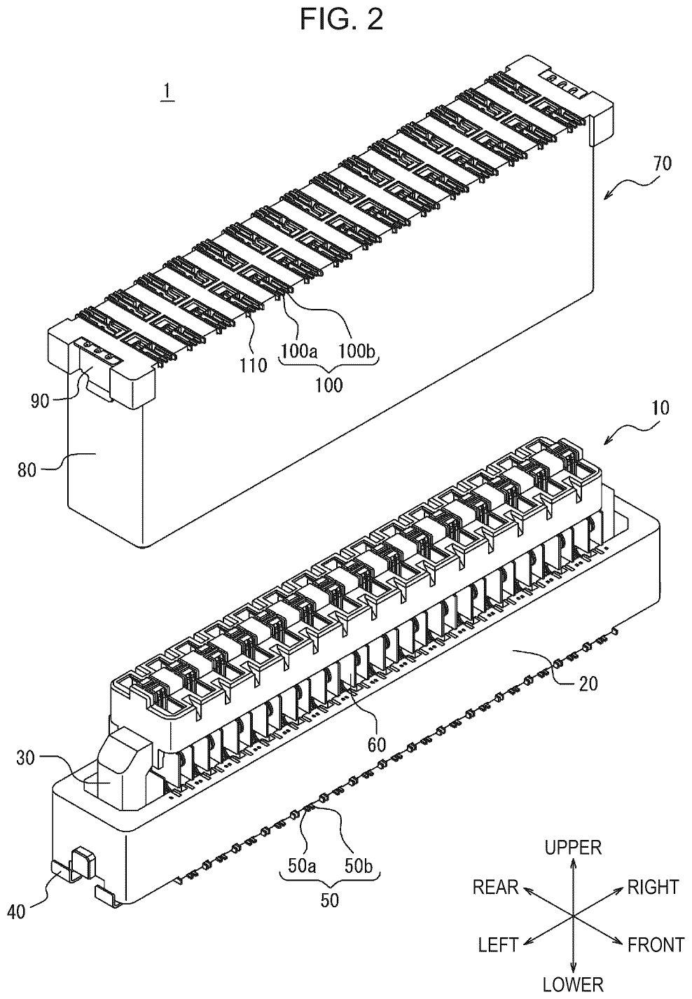

FIG. 1 is a perspective view of a connector 10 according to an embodiment with a connection target 70 connected to it, illustrating its outer appearance from above. FIG. 2 is a perspective view of the connector 10 according to an embodiment with the connection target 70 separated from it, illustrating its outer appearance from above. For example, as illustrated in FIG. 2, a connector module 1 includes the connector 10 and the connection target 70. The connector 10 includes a first insulator 20, which is a stationary insulator, a second insulator 30, which is a movable insulator, metal members 40, first contacts 50a and second contacts 50b, and shield members 60. In the following, when the first contact 50a and the second contact 50b are not distinguished from each other, they are simply referred to as the “contacts 50”. The connection target 70 includes an insulator 80, metal members 90, first contacts 100a and second contacts 100b, and shield members 110. In the following, when the first contact 100a and the second contact 100b are not distinguished from each other, they are simply referred to as the “contacts 100”.

In the following description, for example, the connector 10 according to an embodiment is a plug connector. In the following description, for example, the connection target 70 is a receptacle connector. In the following description, the connector 10 in which the portions of the contacts 50 in contact with the contacts 100 are not elastically deformed in the mated state in which the second insulator 30 of the connector 10 and the connection target 70 are mated with each other is a plug connector. In the following description, the connection target 70 in which the portions of the contacts 100 in contact with the contacts 50 are elastically deformed in the mated state is a receptacle connector. However, the types of the connector 10 and the connection target 70 are not limited to these. For example, the connector 10 may serve as a receptacle connector, and the connection target 70 may serve as a plug connector.

In the following description, the connector 10 and the connection target 70 are mounted on the circuit boards CB1 and CB2, respectively. The connector 10 electrically connects the circuit board CB2, on which the connection target 70 is mounted, to the circuit board CB1, with the connection target 70 mated with the second insulator 30 of the connector 10 interposed therebetween. The circuit boards CB1 and CB2 may be rigid boards or any type of circuit board other than rigid boards. For example, at least one of the circuit board CB1 or CB2 may be a flexible printed circuit board (FPC).

In the following description, the connector 10 and the connection target 70 are connected to each other in the direction perpendicular to the circuit boards CB1 and CB2. The connector 10 and the connection target 70 are connected to each other in the up-down direction, as an example. The mating direction in which the second insulator 30 and the connection target 70 are mated with each other is orthogonal to the circuit board CB1.

The connection method is not limited to the above configuration. The connector 10 and the connection target 70 may be connected to each other in a direction parallel to the circuit boards CB1 and CB2. The connector 10 and the connection target 70 may be connected to each other such that one of them is connected in the direction perpendicular to the circuit board on which the one is mounted and that the other is connected in a direction parallel to the circuit board on which the other is mounted.

The term “mating direction” used in the following description refers to the up-down direction as an example. The term “the lateral direction of the connector 10” refers to the front-rear direction as an example. The term “the longitudinal direction of the connector 10” refers to the right-left direction as an example. The term “the arrangement direction of the multiple pairs of contacts 50” has the same meaning as the arrangement direction of the multiple contacts 50 and refers to the right-left direction as an example. The term “mating side” refers to the lower side as an example. The “removing side” refers to the upper side as an example.

The term “mated state” denotes a state in which the second insulator 30 of the connector 10 and the connection target 70 are mated with each other and in which the contacts 100 are elastically deformed by being in contact with the contacts 50. The term “non-mated state” denotes a state in which the second insulator 30 of the connector 10 and the connection target 70 are not mated with each other and in which the contacts 100 are not elastically deformed by an external force. The term “parallel to” denotes being in a plane parallel to a constituent portion, direction, or the like of interest. However, it is not limited to this definition, but the term “parallel to” may also denote being in a curved surface, being inclined, or other states relative to a constituent portion, direction, or the like of interest. For example, the statement “The first shield portion 61a is located so as to overlap the contacts 50 ‘to be parallel’ to the first direction.” denotes that the first shield portion 61a may be located so as to overlap the contacts 50 to be in a plane parallel to the first direction, that the first shield portion 61a may be located so as to overlap the contacts 50 to be in a curved face parallel to the first direction, or that the first shield portion 61a may be located so as to overlap the contacts 50 to be inclined relative to the first direction.

In an embodiment, the connector 10 has a floating structure. The connector 10 allows the connection target 70 connected to the connector 10 to move in six directions, the upward, downward, front, rear, right, and left directions, relative to the circuit board CB1. The connection target 70 can move within specified ranges in the six directions, the upward, downward, front, rear, right, and left directions, relative to the circuit board CB1 in the state in which the connection target 70 is connected to the connector 10. The connection target 70 may be able to move within specified ranges not only in the six directions, the upward, downward, front, rear, right, and left directions, but also in oblique directions between the six directions.

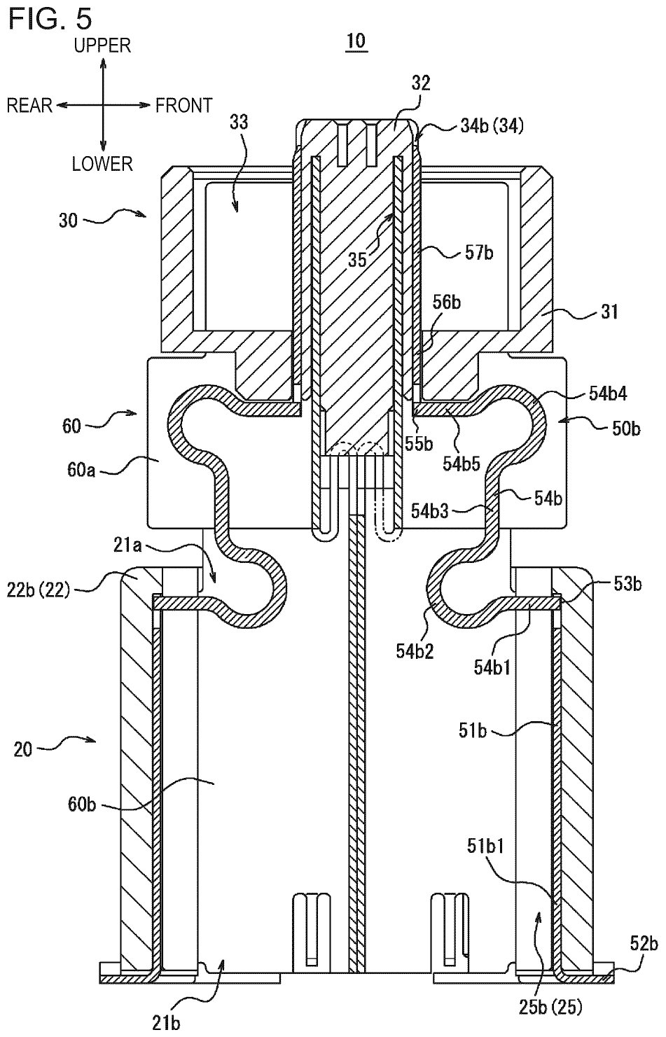

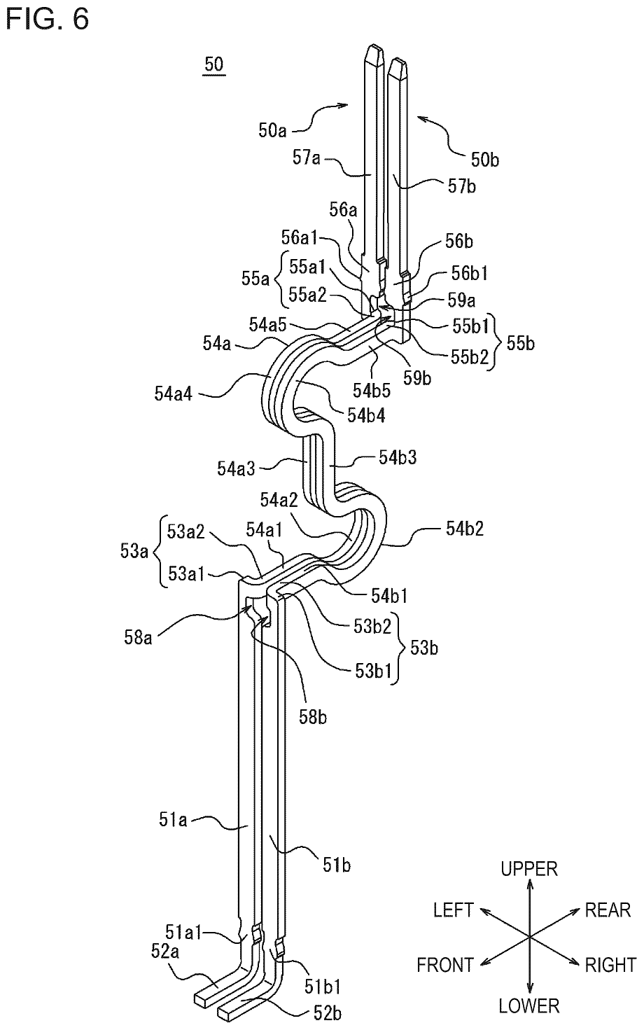

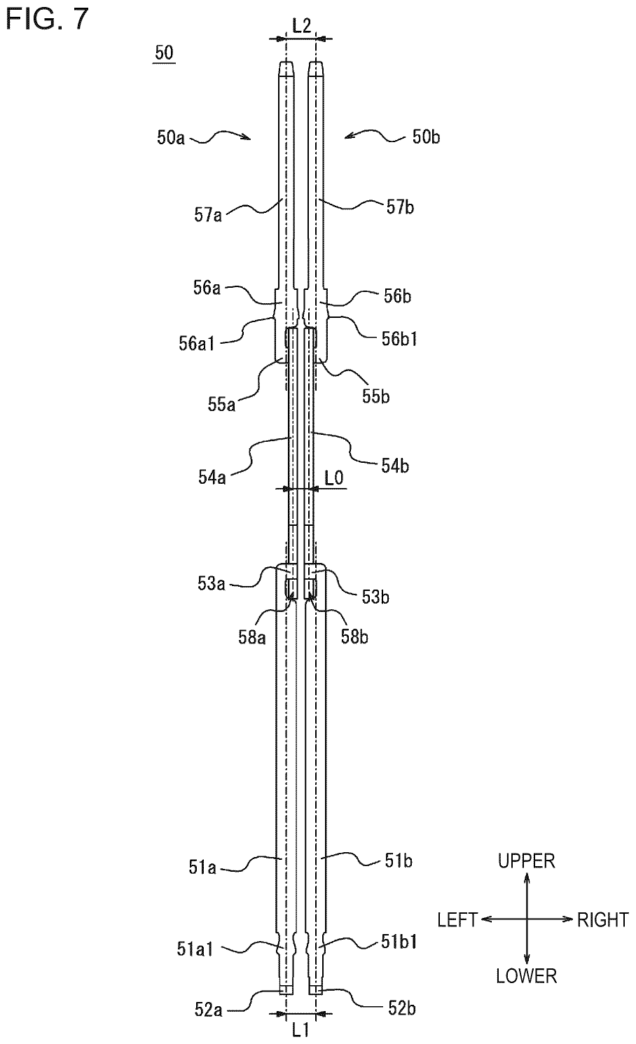

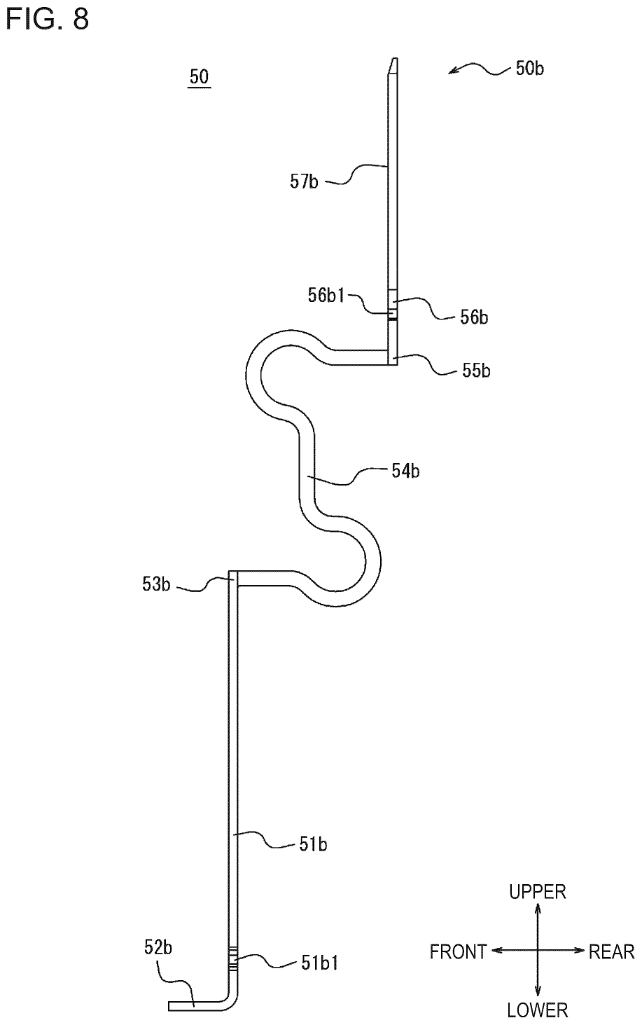

FIG. 3 is a perspective view of the connector 10 in FIG. 1 alone, illustrating its outer appearance from above. FIG. 4 is an exploded perspective view of the connector 10 in FIG. 3 from above. FIG. 5 is a cross-sectional view taken along arrow line V-V in FIG. 3. FIG. 6 is a perspective view of a pair of contacts 50 in FIG. 4, illustrating its outer appearance from above. FIG. 7 is a front view of the pair of contacts 50 in FIG. 6. FIG. 8 is a side view of the pair of contacts 50 in FIG. 6.

As illustrated in FIG. 4, the connector 10 is assembled in the following method as an example. The metal members 40 are press-fitted into the first insulator 20 from below. The second insulator 30 is placed at the first insulator 20 from above. The contacts 50 are press-fitted into the first insulator 20 and the second insulator 30 from below. The shield members 60 are press-fitted into the first insulator 20 and the second insulator 30 from below.

The following mainly describes the configuration of each component of the connector 10 in the non-mated state. Mainly the configuration of the first insulator 20 will be described mainly with reference to FIG. 4.

As illustrated in FIG. 4, the first insulator 20 is a member extending in the right-left direction, injection-molded with an insulating and heat-resistant plastic material. The first insulator 20 is frame-shaped. The first insulator 20 includes openings 21a and 21b on the upper face and the lower face, respectively. The first insulator 20, which includes four side surfaces, includes an outer peripheral wall 22 surrounding the internal space. More specifically, the outer peripheral wall 22 includes a pair of lateral walls 22a on both the right and left sides and a pair of longitudinal walls 22b on both the front and rear sides. The pair of lateral walls 22a and the pair of longitudinal walls 22b are orthogonal to one another and compose the outer peripheral wall 22.

The first insulator 20 includes first restriction portions 23a formed by the inner surfaces of the lateral walls 22a. The first insulator 20 includes second restriction portions 23b formed by the inner surfaces of the longitudinal walls 22b. The first insulator 20 includes metal-member attachment grooves 24 formed so as to be recessed inside the approximately entire lateral walls 22a. The metal-member attachment grooves 24 are configured to receive the metal members 40.

The first insulator 20 includes multiple contact attachment grooves 25 extending in the up-down direction on the inner surfaces of the longitudinal walls 22b. The contact attachment grooves 25 include first-contact attachment grooves 25a and second-contact attachment grooves 25b. The contact attachment grooves 25 are each configured to receive one of the contacts 50. More specifically, each of the first-contact attachment grooves 25a is configured to receive one of the first contacts 50a. Each of the second-contact attachment grooves 25b is configured to receive one of the second contacts 50b. Multiple pairs of contact attachment grooves 25 are recesses spaced at specified intervals in the right-left direction.

The first insulator 20 includes multiple attachment grooves 26 formed so as to extend in the up-down direction on the inner surfaces of the longitudinal walls 22b. The attachment grooves 26 are located symmetrically on both sides of contact attachment grooves 25 so as to flank the contact attachment grooves 25 from on both the right and left sides. The attachment grooves 26 are each configured to receive one of the shield members 60. The multiple attachment grooves 26 are recesses spaced at specified intervals in the right-left direction.

The first insulator 20 includes partition portions 27 each separating a set of contact attachment grooves 25 and attachment grooves 26 from another set in the right-left direction, each set including a pair of contact attachment grooves 25 and a pair of attachment grooves 26 located on each of the front and rear longitudinal walls 22b so as to face each other. Each partition portion 27 extends over approximately the entire inner side of the outer peripheral wall 22 in the up-down direction and also extends in the front-rear direction so as to connect one longitudinal wall 22b and the other longitudinal wall 22b.

The configuration of the second insulator 30 will be described mainly with reference to FIG. 4. The second insulator 30 is located in the internal space surrounded by the outer peripheral wall 22 of the first insulator 20 with the opening 21a interposed therebetween and is movable relative to the first insulator 20. The second insulator 30 is configured to be mated with the connection target 70.

The second insulator 30 is a member extending in the right-left direction, injection-molded with an insulating and heat-resistant plastic material. The second insulator 30 includes a base portion 31 located at its upper portion and extending in the right-left direction. The second insulator 30 includes a mating protrusion 32 protruding upward in a center portion in the front-rear direction of the base portion 31 and configured to be mated with the connection target 70. The second insulator 30 includes multiple mating recesses 33 recessed in the base portion 31 and aligned in the right-left direction on both the front and rear sides of the mating protrusion 32.

The second insulator 30 includes multiple contact attachment grooves 34 recessed in the front and rear outer surfaces of the mating protrusion 32 and extending over approximately the entire mating protrusion 32 in the up-down direction. The contact attachment grooves 34 include first-contact attachment grooves 34a and second-contact attachment grooves 34b. The multiple contact attachment grooves 34 are each configured to receive one of the contacts 50. More specifically, the multiple first-contact attachment grooves 34a are each configured to receive one of the first contacts 50a. The multiple second-contact attachment grooves 34b are each configured to receive one of the second contacts 50b. Multiple pairs of contact attachment grooves 34 are recesses spaced at specified intervals in the right-left direction.

The second insulator 30 includes multiple attachment grooves 35 each extending parallel to both the right and left inner surfaces of each mating recess 33 to the inside of the mating protrusion 32. The attachment grooves 35 are located symmetric with respect to the corresponding contact attachment grooves 34 so as to surround the contact attachment grooves 34 from both the right and left sides of the contact attachment grooves 34 and the center side of the second insulator 30 in the front-rear direction. The attachment grooves 35 are each configured to receive one of the shield members 60. The multiple attachment grooves 35 are recesses spaced at specified intervals in the right-left direction.

The second insulator 30 includes restriction receiving portions 36 located on both the right and left sides of a lower end portion of the base portion 31, protruding outward in the right-left direction in one step, and then extending downward. The second insulator 30 includes first restriction receiving portions 36a formed by the outer surfaces of the restriction receiving portions 36 in the right-left direction. The second insulator 30 includes second restriction receiving portions 36b formed by the outer surfaces of the restriction receiving portions 36 in the front-rear direction.

The configuration of the metal member 40 will be described mainly with reference to FIG. 4.

The metal member 40 is formed by processing a thin plate of a certain metal material into the shape illustrated in FIG. 4 by using a progressive die (stamping). The processing method of the metal member 40 includes punching and then bending in the thickness direction. The metal member 40 has an H shape in side view in the right-left direction.

The metal member 40 includes mount portions 41 located at lower end portions on both the front and rear sides of the metal member 40 and extending outward in a U shape. The metal member 40 includes engagement portions 42 extending upward from upper ends of the mount portions 41. The metal member 40 includes a base portion 43 extending in the front-rear direction so as to connect the engagement portions 42 on both the front and rear sides.

The configuration of the contact 50 will be described mainly with reference to FIGS. 4 to 8.

The contact 50 is formed, for example, by processing a thin plate composed of a copper alloy having a spring elasticity such as phosphor bronze, beryllium copper, or titanium copper, or a Corson copper alloy into the shape illustrated in FIGS. 4 to 8 by using a progressive die (stamping). The contact 50 is formed by punching and then bending in the thickness direction. The contact 50 includes, for example, a metal material having a low elastic modulus so that the shape change along with elastic deformation can be large. The surface of the contact 50 is undercoated with nickel plating and then plated with gold, tin, or the like.

As illustrated in FIG. 4, the multiple pairs of contacts 50 are arranged in the longitudinal direction of the connector 10. The multiple contacts 50 are arranged in the longitudinal direction of the connector 10. As illustrated in FIG. 5, the contacts 50 are attached to the first insulator 20 and the second insulator 30. The contacts 50 of a pair located at the same right-left position are symmetric in the front-rear direction. The contacts 50 of the pair are located to be line-symmetric with respect to the vertical axis passing through the center between the contacts 50 of the pair. As illustrated in FIG. 7, the contacts 50 of a pair located at the same front-rear position are symmetric in the arrangement direction of the multiple pairs of contacts 50. The contacts 50 of the pair are located to be line-symmetric with respect to the vertical axis passing through the center between the contacts 50 of the pair.

As illustrated in FIGS. 6 to 8, the first contact 50a of a pair of contacts 50 includes a first base portion 51a extending in the up-down direction and configured to be supported by the first insulator 20. The first base portion 51a includes a first held portion 51a1 located at a lower part of the first base portion 51a. The first contact 50a includes a mount portion 52a located at a lower end portion of the first held portion 51a1 and extending outward in an L shape. The first base portion 51a extends from the mount portion 52a along the first insulator 20 and located along the first insulator 20. The first contact 50a includes a first connection portion 53a bent from an upper end portion of the first base portion 51a at an angle of approximately 90° in an L shape toward the second insulator 30 side, in other words, inward in the front-rear direction.

The first contact 50a includes an elastically deformable elastic portion 54a connected to the first connection portion 53a. The first contact 50a includes a second connection portion 55a bent from an end portion of the elastic portion 54a at an angle of approximately 90° in an L shape outward in the right-left direction. The first contact 50a includes a second base portion 56a extending in the up-down direction and configured to be supported by the second insulator 30. The second base portion 56a includes a second held portion 56a1 which is on the second insulator 30 side and corresponds to the first held portion 51al. The second held portion 56a1 is a wider portion of the second base portion 56a in the right-left direction. The second base portion 56a extends from the second connection portion 55a along the second insulator 30 and located along the second insulator 30. The first contact 50a includes a contact portion 57a located on an outer surface of the second base portion 56a in the front-rear direction.

The first contact 50a includes a first cutout portion 58a located between the first connection portion 53a and a wider portion of the first base portion 51a in the right-left direction and extending in the up-down direction. Part of the wider portion of the first base portion 51a in the right-left direction and part of the first connection portion 53a face each other in the up-down direction with the first cutout portion 58a interposed therebetween.

The first contact 50a includes a second cutout portion 59a located between the second connection portion 55a and the wider portion of the second base portion 56a in the right-left direction and extending in the up-down direction. Part of the wider portion of the second base portion 56a in the right-left direction and part of the second connection portion 55a face each other in the up-down direction with the second cutout portion 59a interposed therebetween.

The first connection portion 53a connects one end of the elastic portion 54a and the first base portion 51a. The second connection portion 55a connects the other end of the elastic portion 54a and the second base portion 56a. The elastically deformable elastic portion 54a is located between the first base portion 51a and the second base portion 56a. More specifically, the elastic portion 54a is located between the first connection portion 53a and the second connection portion 55a.

The elastic portion 54a includes a first extension portion 54a1 extending in a straight line from the first connection portion 53a toward the second insulator 30 side. The elastic portion 54a includes a first curved portion 54a2 first extending from the first extension portion 54a1 obliquely downward and then curved in a C shape as a whole. The first curved portion 54a2 has an arc shape curved from the first extension portion 54a1 in a gentle round shape the end portion of which faces the first insulator 20 side. The first curved portion 54a2 has an arc shape corresponding to a sector shape having a central angle of 180° or more.

The elastic portion 54a includes a second extension portion 54a3 further curved from the first curved portion 54a2 in an L shape and then extending upward in a straight line. The elastic portion 54a includes a second curved portion 54a4 first extending from the second extension portion 54a3 obliquely upward and then curved in an inverted C shape as a whole. The second curved portion 54a4 has an arc shape curved from the second extension portion 54a3 in a gentle round shape the end portion of which faces the second insulator 30 side. The second curved portion 54a4 has an arc shape corresponding to a sector shape having a central angle of 180° or more.

The elastic portion 54a includes a third extension portion 54a5 extending in a straight line from the second curved portion 54a4 toward the second insulator 30 side.

The second contact 50b of a pair of contacts 50 includes a first base portion 51b extending in the up-down direction and configured to be supported by the first insulator 20. The first base portion 51b includes a first held portion 51b1 located at a lower part of the first base portion 51b. The second contact 50b includes a mount portion 52b located at a lower end portion of the first held portion 51b1 and extending outward in an L shape. The first base portion 51b extends from the mount portion 52b along the first insulator 20 and located along the first insulator 20. The second contact 50b includes a first connection portion 53b bent from an upper end portion of the first base portion 51b at an angle of approximately 90° in an L shape toward the second insulator 30 side, in other words, inward in the front-rear direction.

The second contact 50b includes an elastically deformable elastic portion 54b connected to the first connection portion 53b. The second contact 50b includes a second connection portion 55b bent from an end portion of the elastic portion 54b at an angle of approximately 90° in an L shape outward in the right-left direction. The second contact 50b includes a second base portion 56b extending in the up-down direction and configured to be supported by the second insulator 30. The second base portion 56b includes a second held portion 56b1 which is on the second insulator 30 side and corresponds to the first held portion 51b1. The second held portion 56b1 is a wider portion of the second base portion 56b in the right-left direction. The second base portion 56b extends from the second connection portion 55b along the second insulator 30 and located along the second insulator 30. The second contact 50b includes a contact portion 57b located on an outer surface of the second base portion 56b in the front-rear direction.

The second contact 50b includes a first cutout portion 58b located between the first connection portion 53b and a wider portion of the first base portion 51b in the right-left direction and extending in the up-down direction. Part of the wider portion of the first base portion 51b in the right-left direction and part of the first connection portion 53b face each other in the up-down direction with the first cutout portion 58b interposed therebetween.

The second contact 50b includes a second cutout portion 59b located between the second connection portion 55b and the wider portion of the second base portion 56b in the right-left direction and extending in the up-down direction. Part of the wider portion of the second base portion 56b in the right-left direction and part of the second connection portion 55b face each other in the up-down direction with the second cutout portion 59b interposed therebetween.

The first connection portion 53b connects one end of the elastic portion 54b and the first base portion 51b. The second connection portion 55b connects the other end of the elastic portion 54b and the second base portion 56b. The elastically deformable elastic portion 54b is located between the first base portion 51b and the second base portion 56b. More specifically, the elastic portion 54b is located between the first connection portion 53b and the second connection portion 55b.

The elastic portion 54b includes a first extension portion 54b1 extending in a straight line from the first connection portion 53b toward the second insulator 30 side. The elastic portion 54b includes a first curved portion 54b2 first extending from the first extension portion 54b1 obliquely downward and then curved in a C shape as a whole. The first curved portion 54b2 has an arc shape curved from the first extension portion 54b1 in a gentle round shape the end portion of which faces the first insulator 20 side. The first curved portion 54b2 has an arc shape corresponding to a sector shape having a central angle of 180° or more.

The elastic portion 54b includes a second extension portion 54b3 further curved from the first curved portion 54b2 in an L shape and then extending upward in a straight line. The elastic portion 54b includes a second curved portion 54b4 first extending from the second extension portion 54b3 obliquely upward and then curved in an inverted C shape as a whole. The second curved portion 54b4 has an arc shape curved from the second extension portion 54b3 in a gentle round shape the end portion of which faces the second insulator 30 side. The second curved portion 54b4 has an arc shape corresponding to a sector shape having a central angle of 180° or more.

The elastic portion 54b includes a third extension portion 54b5 extending in a straight line from the second curved portion 54b4 toward the second insulator 30 side.

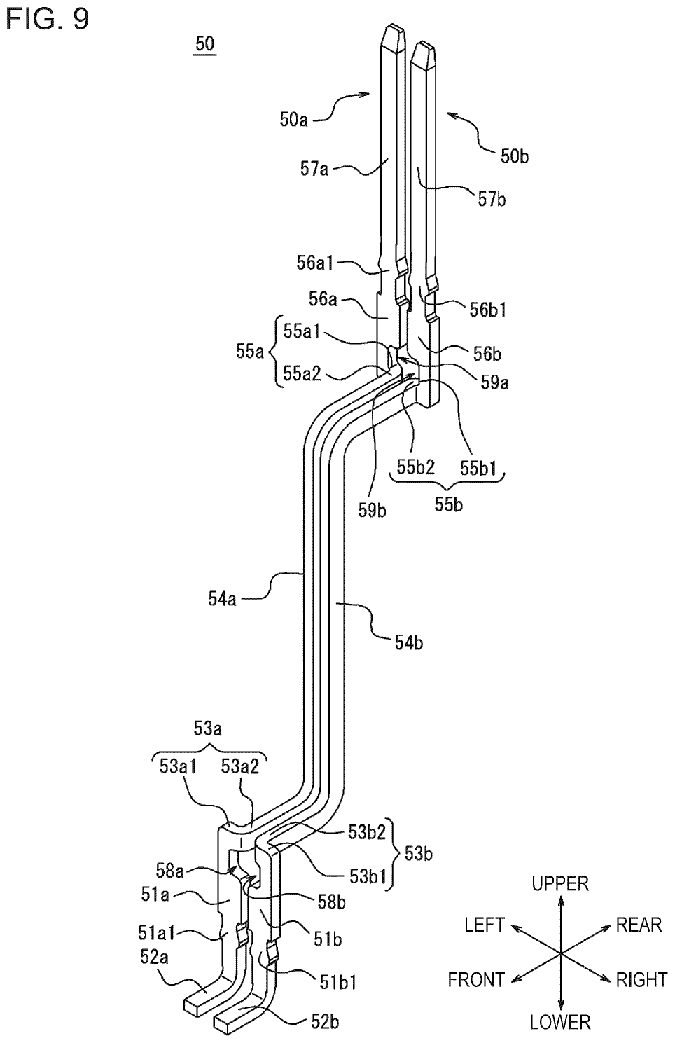

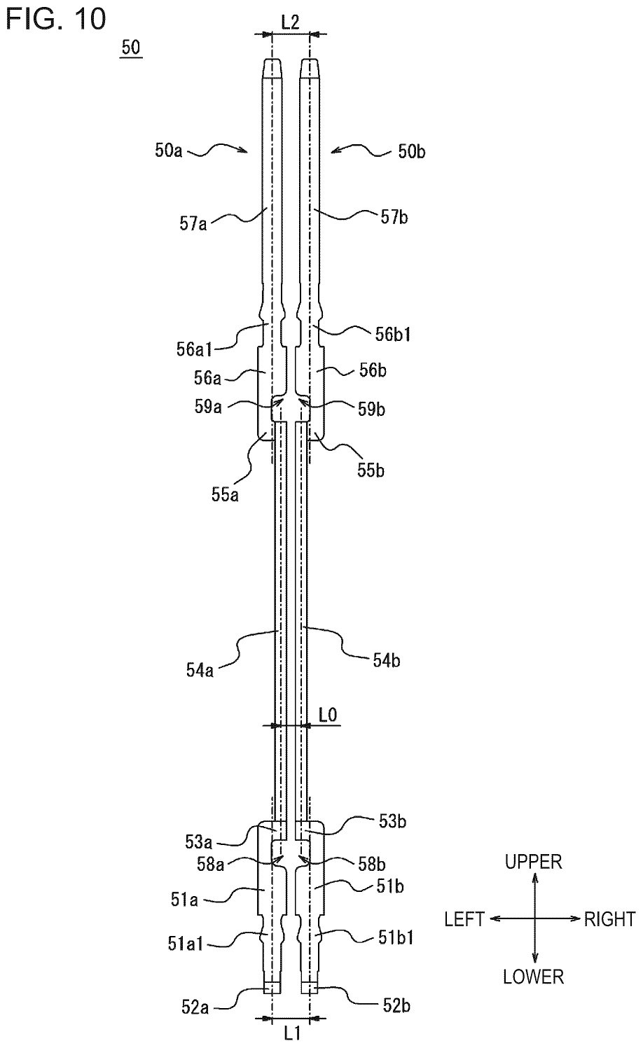

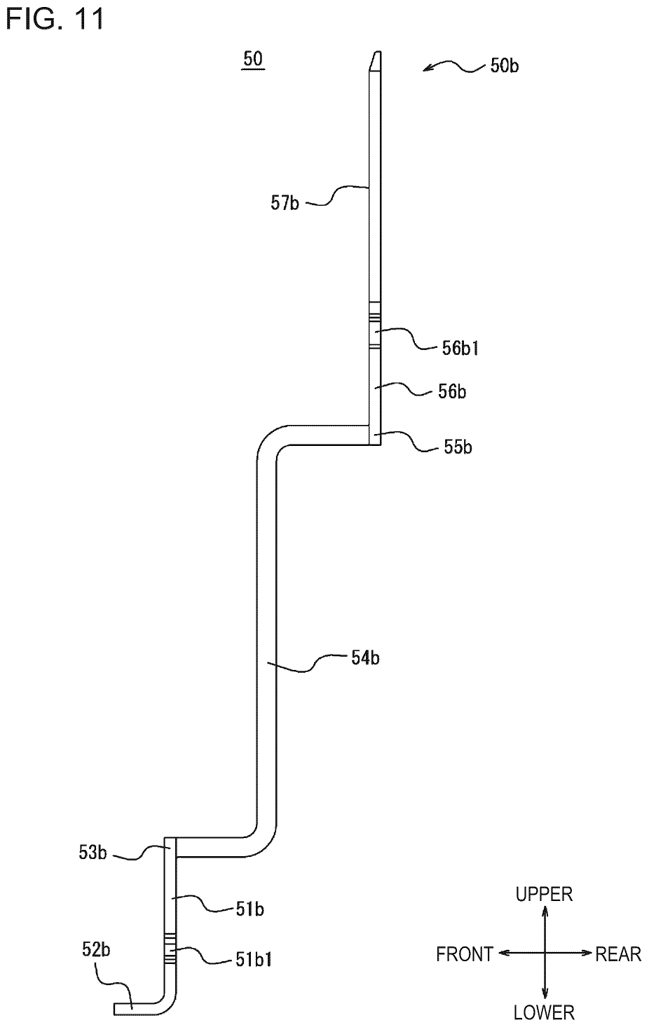

FIG. 9 is a perspective view of a pair of contacts 50 according to another example, illustrating their outer appearances from above. FIG. 10 is a front view of the pair of contacts 50 in FIG. 9. FIG. 11 is a side view of the pair of contacts 50 in FIG. 9. The shapes of the contacts 50 are not limited to the ones illustrated in FIGS. 4 to 8.

When the contacts 50 have the constituent portions the same as the ones illustrated in FIGS. 4 to 8, the shapes may differ. More specifically, the first contact 50a and the second contact 50b may include shorter first base portions 51a and 51b in the up-down direction. The first contact 50a and the second contact 50b may include elastic portions 54a and 54b having significantly different shapes. As illustrated in FIGS. 9 to 11, each of the elastic portions 54a and 54b may have a crank shape in side view in the right-left direction.

In the following, when the elastic portion 54a and the elastic portion 54b are not distinguished from each other, they are simply referred to as the “elastic portions 54”. Similarly, when other constituent portions are not distinguished between the first contact 50a and the second contact 50b, only corresponding numbers will be used as reference symbols without “a” and “b”.

As illustrated in FIGS. 6 to 11, in the first contact 50a of a pair of contacts 50, a first surface of the entire elastic portion 54a, orthogonal to the thickness direction of the contact 50, faces a first surface of the elastic portion 54b of the second contact 50b. In the second contact 50b of the pair of contacts 50, a first surface of the entire elastic portion 54b, orthogonal to the thickness direction of the contact 50, faces a first surface of the elastic portion 54a of the first contact 50a. In the present disclosure, the “first surface” is, for example, a rolled surface. In FIGS. 6 to 11, the first surfaces of an elastic portion 54 are, for example, the surfaces facing the right-left direction. The entire elastic portions 54 of a pair face each other in the arrangement direction of the multiple pairs of contacts 50 at their corresponding first surfaces.

The first base portions 51 of a pair face each other in the arrangement direction of the multiple pairs of contacts 50 at their corresponding second surfaces parallel to the thickness direction of the contacts 50. The second base portions 56 of a pair face each other in the arrangement direction of the multiple pairs of contacts 50 at their corresponding second surfaces parallel to the thickness direction of the contacts 50. In the present disclosure, the “second surface” is, for example, a fracture surface. In FIGS. 6 to 11, the second surfaces of the first base portions 51 and the second surfaces of the second base portions 56 are, for example, the surfaces facing the right-left direction.

As described above, in the contacts 50, the rolled surfaces of the first base portions 51 and the second base portions 56 face the front-rear direction, and the rolled surfaces of the elastic portions 54 face the right-left direction. In the contacts 50, the fracture surfaces of the first base portions 51 and the second base portions 56 face the right-left direction, and the fracture surfaces of the elastic portions 54 face various directions orthogonal to the right-left direction.

As illustrated in FIGS. 6 and 9, in the first contact 50a of a pair of contacts 50, the first connection portion 53a and the second connection portion 55a include a first portion 53a1 and a first portion 55al, respectively.

The first portion 53a1 extends from the corresponding first base portion 51a toward the second contact 50b in the arrangement direction of the multiple pairs of contacts 50 such that the elastic portion 54a is closer to the elastic portion 54b of the second contact 50b in the arrangement direction. The first portion 53a1 extends from the corresponding first base portion 51a toward the second contact 50b in the arrangement direction such that the distance between the elastic portions 54 of the pair is shorter in the arrangement direction than the arrangement distance of the contacts 50 of the pair.

The first portion 55a1 extends from the corresponding second base portion 56a toward the second contact 50b in the arrangement direction of the multiple pairs of contacts 50 such that the elastic portion 54a is closer to the elastic portion 54b of the second contact 50b in the arrangement direction. The first portion 55a1 extends from the corresponding second base portion 56a toward the second contact 50b in the arrangement direction such that the distance between the elastic portions 54 of the pair is shorter in the arrangement direction than the arrangement distance of the contacts 50 of the pair.

In the second contact 50b of a pair of contacts 50, the first connection portion 53b and the second connection portion 55b include a first portion 53b1 and a first portion 55b1, respectively.

The first portion 53b1 extends from the corresponding first base portion 51b toward the first contact 50a in the arrangement direction of the multiple pairs of contacts 50 such that the elastic portion 54b is closer to the elastic portion 54a of the first contact 50a in the arrangement direction. The first portion 53b1 extends from the corresponding first base portion 51b toward the first contact 50a in the arrangement direction such that the distance between the elastic portions 54 of the pair is shorter in the arrangement direction than the arrangement distance of the contacts 50 of the pair.

The first portion 55b1 extends from the corresponding second base portion 56b toward the first contact 50a in the arrangement direction of the multiple pairs of contacts 50 such that the elastic portion 54b is closer to the elastic portion 54a of the first contact 50a in the arrangement direction. The first portion 55b1 extends from the corresponding second base portion 56b toward the first contact 50a in the arrangement direction such that the distance between the elastic portions 54 of the pair is shorter in the arrangement direction than the arrangement distance of the contacts 50 of the pair.

Each first connection portion 53 connects the corresponding first base portion 51 and elastic portion 54 such that the elastic portions 54 of the pair are located inward of the first base portions 51 of the pair in the arrangement direction mentioned above. More specifically, each first connection portion 53 connects the corresponding first base portion 51 and elastic portion 54 such that the outer edge portions of the elastic portions 54 of the pair are located inward of the outer edge portions of the first base portions 51 of the pair in the arrangement direction mentioned above. Each first connection portion 53 connects the corresponding first base portion 51 and elastic portion 54 such that the center lines of the elastic portions 54 are located inward of the center lines of the first base portions 51 in the arrangement direction mentioned above.

Each second connection portion 55 connects the corresponding second base portion 56 and elastic portion 54 such that the elastic portions 54 of the pair are located inward of the second base portions 56 of the pair in the arrangement direction mentioned above. More specifically, each second connection portion 55 connects the corresponding second base portion 56 and elastic portion 54 such that the outer edge portions of the elastic portions 54 of the pair are located inward of the outer edge portions of the second base portions 56 of the pair in the arrangement direction mentioned above. Each second connection portion 55 connects the corresponding second base portion 56 and elastic portion 54 such that the center lines of the elastic portions 54 are located inward of the center lines of the second base portions 56 in the arrangement direction mentioned above.

As illustrated in FIGS. 7 and 10, in the arrangement direction of the multiple pairs of contacts 50, the distance L0 between the paired center lines of the elastic portions 54 of a pair is shorter than the distance L1 between the paired center lines of the first base portions 51 of the pair and the distance L2 of the paired center lines of the second base portions 56 of the pair.

As illustrated in FIGS. 6 and 9, in the first contact 50a of a pair of contacts 50, the first connection portion 53a and the second connection portion 55a include a second portion 53a2 and a second portion 55a2, respectively. The second portion 53a2 is bent from the first portion 53a1 toward the other insulator side, specifically, the second insulator 30 side. The second portion 55a2 is bent from the first portion 55a1 toward the other insulator side, specifically, the first insulator 20 side.

In the second contact 50b of the pair of contacts 50, the first connection portion 53b and the second connection portion 55b include a second portion 53b2 and a second portion 55b2, respectively. The second portion 53b2 is bent from the first portion 53b1 toward the other insulator side, specifically, the second insulator 30 side. The second portion 55b2 is bent from the first portion 55b1 toward the other insulator side, specifically, the first insulator 20 side.

The paired first cutout portions 58 of the contacts 50 of a pair are located on the inner sides of the contacts 50 of the pair in the right-left direction. The first cutout portions 58 of the pair face each other on the inner sides of the contacts 50 of the pair in the right-left direction. The paired second cutout portions 59 of the contacts 50 of a pair are located on the inner sides of the contacts 50 of the pair in the right-left direction. The second cutout portions 59 of the pair face each other on the inner sides of the contacts 50 of the pair in the right-left direction.

As illustrated in FIGS. 8 and 11, when viewed in the arrangement direction of the multiple pairs of contacts 50, the width over which the elastic portions 54 of a pair overlap each other is larger than the width over which the first base portions 51 of the pair overlap each other and the width over which the second base portions 56 of the pair overlap each other in the direction orthogonal to the extending direction of the contacts 50. For example, in an elastic portion 54 having a crank shape as illustrated in FIG. 11, the direction orthogonal to the extending direction of the contact 50 is the up-down direction in a portion extending in the front-rear direction, and it is the front-rear direction in a portion extending in the front-rear direction. For example, in an elastic portion 54 including curved portions having gentle curved lines as illustrated in FIG. 8, the direction orthogonal to the extending direction of the contact 50 is the radial direction of the radius of the curvature at each curved portion.

FIG. 12 is a perspective view of a set of a pair of contacts 50 and a shield member 60 in FIG. 4, illustrating their outer appearances from above. FIG. 13 is a perspective view of four sets of the pair of contacts 50 and the shield member 60 in FIG. 12, illustrating their outer appearances from above. FIG. 14 is a front view of the pairs of contacts 50 and the shield members 60 in FIG. 13.

The configuration of the shield member 60 will be described mainly with reference to FIGS. 4 and 12 to 14.

The shield member 60 is formed by processing a thin plate of a certain metal material into the shape illustrated in FIGS. 4 and 12 to 14 by using a progressive die (stamping). The processing method of the shield member 60 includes punching and then bending in the thickness direction. The shield member 60 has a shape along continuous three sides of a rectangle in top view.

As illustrated in FIG. 4, the multiple shield members 60 are arranged in the longitudinal direction of the connector 10. The shield members 60 are attached to the first insulator 20 and the second insulator 30. More specifically, the shield members 60 each include a first shield member 60a attached to the second insulator 30 and a second shield member 60b attached to the first insulator 20.

As illustrated in FIG. 13, the shield members 60 of a pair located at the same right-left position are symmetric in the front-rear direction. The shield members 60 of the pair are point-symmetric with respect to the center point between them in top view. As illustrated in FIG. 14, The shield members 60 of each pair located in the same front-rear position have the same shape and arrangement in the arrangement direction of the multiple pairs of contacts 50.

As illustrated in FIGS. 12 to 14, the first shield member 60a includes a pair of first shield portions 61a extending in planes in the front-rear direction. The first shield member 60a includes a second shield portion 62a extending in a plane in the right-left direction and connecting, in the right-left direction, the first shield portions 61a of the pair away from each other in the front-rear direction. The first shield member 60a includes a first held portion 63a extending upward in a straight line from the center of the upper edge portion of the second shield portion 62a.

The second shield member 60b includes a pair of third shield portions 61b extending in planes in the front-rear direction. The second shield member 60b includes a fourth shield portion 62b extending in a plane in the right-left direction and connecting, in the right-left direction, the third shield portions 61b of the pair away from each other in the front-rear direction. The second shield member 60b includes second held portions 63b extending upward in straight lines from upper end portions of end portions in the front-rear direction of the third shield portions 61b. The second shield member 60b includes mount portions 64b extending outward in the front-rear direction in straight lines from lower end portions of end portions in the front-rear direction of the third shield portions 61b. The second shield member 60b includes an elastically deformable first spring portion 65b at a center portion in the front-rear direction of a lower portion of one third shield portion 61b. The second shield member 60b includes an elastically deformable second spring portion 66b at an inner portion in the front-rear direction of a lower portion of the other third shield portion 61b.

The shield member 60 includes an elastically deformable connection portion 67 connecting a lower edge portion of the second shield portion 62a of the first shield member 60a and an upper edge portion of the fourth shield portion 62b of the second shield member 60b. The connection portion 67 extends from a lower edge portion of the second shield portion 62a, is bent in a J shape, is then bent in an inverted J shape, and is connected to an upper edge portion of the fourth shield portion 62b.

Each shield member 60 is located between a pair of contacts 50 and the other pairs of contacts 50. Each first shield member 60a is located between the multiple contacts 50. Each second shield member 60b is located between the multiple contacts 50.

The first shield portions 61a of the first shield member 60a overlap contacts 50 to be parallel to a first direction intersecting the mating direction in which the connection target 70 and the second insulator 30 are mated with each other. In the present disclosure, the “first direction” refers to the front-rear direction as an example. The first shield portions 61a extend in planes in the first direction and overlap the contacts 50.

The second shield portion 62a of the first shield member 60a overlaps contacts 50 to be parallel to a second direction intersecting the first direction and the mating direction in which the connection target 70 and the second insulator 30 are mated with each other. In the present disclosure, the “second direction” refers to the right-left direction as an example. The second shield portion 62a extends in a plane in the second direction and overlaps the contacts 50.

The third shield portions 61b of the second shield member 60b overlap contacts 50 to be parallel to the first direction intersecting the mating direction in which the connection target 70 and the second insulator 30 are mated with each other. The third shield portions 61b extend in planes in the first direction and overlap the contacts 50.

The fourth shield portion 62b of the second shield member 60b overlaps contacts 50 to be parallel to the second direction intersecting the first direction and the mating direction in which the connection target 70 and the second insulator 30 are mated with each other. The fourth shield portion 62b extends in a plane in the second direction and overlaps the contacts 50.

As illustrated in FIG. 14, the first shield member 60a surrounds the portions of the contacts 50 located above center portions of the elastic portions 54 from both sides in the right-left direction and the inner side in the front-rear direction. The second shield member 60b surrounds the portions of the contacts 50 located below center portions of the elastic portions 54 from both sides in the right-left direction and the inner side in the front-rear direction. The first shield member 60a and the second shield member 60b partially overlap each other to be parallel to the mating direction. As illustrated in FIG. 12, the first shield member 60a and the second shield member 60b are connected to each other by the connection portion 67.

As illustrated in FIG. 13, the multiple second shield members 60b are arranged in the first direction and the second direction. The second shield members 60b of a pair adjacent to each other in the first direction are in contact with each other with a surface contact of the fourth shield portions 62b of the pair interposed therebetween. As illustrated in FIG. 14, the second shield members 60b of a pair adjacent to each other in the second direction are located such that the first spring portion 65b of one second shield member 60b is close to the corresponding third shield portion 61b of the other second shield member 60b and that the second spring portion 66b of the other second shield member 60b is close to the corresponding third shield portion 61b of the one second shield member 60b.

As illustrated in FIG. 13, the multiple first shield members 60a are arranged in the first direction and the second direction. The first shield members 60a of a pair adjacent to each other in the first direction are away from each other with the connection portions 67 of the pair in between. As illustrated in FIG. 14, the first shield members 60a of a pair adjacent to each other in the second direction are away from each other.

The distance between the first base portion 51 of each contact 50 and the second shield member 60b is constant also when the second insulator 30 is moved relative to the first insulator 20. More specifically, the distance in the right-left direction between each first base portion 51 and the third shield portion 61b located outward in the right-left direction is constant.

The distance between the second base portion 56 of each contact 50 and the first shield member 60a is constant also when the second insulator 30 is moved relative to the first insulator 20. More specifically, the distance in the right-left direction between each second base portion 56 and the first shield portion 61a located outward in the right-left direction is constant.

The distance between the elastic portion 54 of each contact 50 and the first shield member 60a is longer than the distance between the second base portion 56 and the first shield member 60a. More specifically, the distance in the right-left direction between each elastic portion 54 and the first shield portion 61a located outward in the right-left direction is longer than the distance in the right-left direction between the corresponding second base portion 56 and the first shield portion 61a located outward in the right-left direction.

The distance between the elastic portion 54 of each contact 50 and the second shield member 60b is longer than the distance between the first base portion 51 and the second shield member 60b. More specifically, the distance in the right-left direction between each elastic portion 54 and the third shield portion 61b located outward in the right-left direction is longer than the distance in the right-left direction between the corresponding first base portion 51 and the third shield portion 61b located outward in the right-left direction.

As can be understood from FIG. 4 and other figures, the first base portions 51 of the contacts 50 are engaged with the contact attachment grooves 25 located in the longitudinal walls 22b of the first insulator 20. The first base portions 51 are attached to the first insulator 20. More specifically, the first base portions 51a of the first contacts 50a are engaged with the first-contact attachment grooves 25a. The first base portions 51b of the second contacts 50b are engaged with the second-contact attachment grooves 25b.

The second base portions 56 of the contacts 50 are engaged with the contact attachment grooves 34 located in the mating protrusion 32 of the second insulator 30. The second base portions 56 are attached to the second insulator 30. More specifically, the second base portions 56a of the first contacts 50a are engaged with the first-contact attachment grooves 34a. The second base portions 56b of the second contacts 50b are engaged with the second-contact attachment grooves 34b.

As illustrated in FIG. 5, when the multiple contacts 50 are attached to the first insulator 20 and the second insulator 30, the contact portion 57 of each contact 50 is located inside the corresponding mating recess 33 of the second insulator 30. The contact portion 57 of each contact 50 is located along the inner surface of the corresponding mating recess 33 in the front-rear direction so as to face the inside of the mating recess 33.

The contacts 50 are supporting the second insulator 30 such that the second insulator 30 is located in the internal space surrounded by the outer peripheral wall 22 of the first insulator 20 and immediately above the outer peripheral wall 22 so as to be away from and floated above the first insulator 20.

When the second insulator 30 is held by the contacts 50 relative to the first insulator 20, the second insulator 30 is located in the internal space surrounded by the outer peripheral wall 22 of the first insulator 20 and immediately above the outer peripheral wall 22 so as to be away from the first insulator 20. More specifically, the base portion 31 of the second insulator 30 is located immediately above the outer peripheral wall 22. The restriction receiving portions 36 of the second insulator 30 are located in the internal space of the first insulator 20, surrounded by the pair of longitudinal walls 22b and the pair of lateral walls 22a. The restriction receiving portions 36 of the second insulator 30 are surrounded by the outer peripheral wall 22 of the first insulator 20.

The base portion 31 of the second insulator 30 protrudes upward from the opening 21a of the first insulator 20 and is located outside the internal space mentioned above of the first insulator 20. The base portion 31 of the second insulator 30 is located above the outer peripheral wall 22 of the first insulator 20 in the state in which the base portion 31 can be mated with the connection target 70.

As can be understood from FIGS. 3 and 4, the second restriction receiving portions 36b of the second insulator 30 are located on the inner sides in the front-rear direction of the second restriction portions 23b located on the longitudinal walls 22b of the first insulator 20. The first restriction receiving portions 36a of the second insulator 30 face the first restriction portions 23a located on the lateral walls 22a of the first insulator 20 from the inner sides in the right-left direction.

As can be understood from FIG. 4 and other figures, the first held portions 63a of the first shield members 60a are engaged with the attachment grooves 35 located in the mating protrusion 32 of the second insulator 30. The first held portions 63a are attached to the second insulator 30. The second held portions 63b of the second shield members 60b are engaged with the attachment grooves 26 located in the longitudinal walls 22b of the first insulator 20. The second held portions 63b are attached to the first insulator 20.

The engagement portions 42 of the metal members 40 are engaged with the metal-member attachment grooves 24 of the first insulator 20. The metal members 40 are press-fitted into the metal-member attachment grooves 24 of the first insulator 20 and located at both the right and left end portions of the first insulator 20.

The connector 10 having a structure as described above is mounted on, for example, a circuit formation surface on a mounting surface of a circuit board CB1. More specifically, the mount portions 41 of the metal members 40 are placed on solder paste applied to pads on the circuit board CB1. The mount portions 52a of the first contacts 50a are placed on solder paste applied to pads on the circuit board CB1. The mount portions 52b of the second contacts 50b are placed on solder paste applied to pads on the circuit board CB1. The mount portions 64b of the second shield members 60b are placed on solder paste applied to pads on the circuit board CB1.

The pieces of solder paste are heated and melted in a reflow oven or the like, so that the mount portions 41, the mount portions 52a, the mount portions 52b, and the mount portions 64b are soldered to the pads mentioned above. Thus, mounting the connector 10 onto the circuit board CB1 is completed. In addition to the connector 10, for example, other electronic components including a central processing unit (CPU), a controller, and a memory are also mounted onto the circuit formation surface of the circuit board CB1.

The structure of the connection target 70 will be described mainly with reference to FIGS. 15 and 16.

FIG. 15 is a perspective view of the connection target 70 configured to be connected to the connector 10 in FIG. 3, illustrating its outer appearance from above. FIG. 16 is an exploded perspective view of the connection target 70 in FIG. 15 from above.

As illustrated in FIG. 16, the connection target 70 is assembled by press-fitting the metal members 90 into the insulator 80 from above and press-fitting the contacts 100 and the shield members 110 into the insulator 80 from below.

The insulator 80 is a member having a rectangular prism shape, formed by injection-molding an insulating and heat-resistant plastic material. The insulator 80 includes a mating recess 81 located on its upper surface. The insulator 80 includes multiple mating protrusions 82 arranged inside the mating recess 81. The insulator 80 includes metal-member attachment grooves 83 located at both the right and left end portions of the lower end of the insulator 80 and extending in the up-down direction. The metal-member attachment grooves 83 are configured to receive the metal members 90.

The insulator 80 includes multiple contact attachment grooves 84 recessed in straight lines over approximately the entire length in the up-down direction inside the insulator 80. The contact attachment grooves 84 include first-contact attachment grooves 84a and second-contact attachment grooves 84b. The multiple contact attachment grooves 84 are each configured to receive one of the multiple contacts 100. More specifically, the multiple first-contact attachment grooves 84a are each configured to receive one of the multiple first contacts 100a. The multiple second-contact attachment grooves 84b are each configured to receive one of the multiple second contacts 100b. Multiple pairs of contact attachment grooves 84 are recesses spaced at specified intervals in the right-left direction.

The insulator 80 includes multiple attachment grooves 85 recessed in straight lines over approximately the entire length in the up-down direction inside the insulator 80. The attachment grooves 85 are located in part of the periphery of contact attachment grooves 84 so as to surround the contact attachment grooves 84 from both sides in the right-left direction and the inner side in the front-rear direction. The multiple attachment grooves 85 are each configured to receive one of the multiple shield members 110. The multiple attachment grooves 85 are recesses spaced at specified intervals in the right-left direction.

The metal member 90 is formed by processing a thin plate of a certain metal material into the shape illustrated in FIG. 16 by using a progressive die (stamping). The metal members 90 are located at both the right and left end portions of the insulator 80. The metal member 90 includes a mount portion 91 located at its lower end portion and extending outward in the right-left direction in an L shape. The metal member 90 includes the mount portion 91. The metal member 90 includes an engagement portion 92 configured to be engaged with the insulator 80. A lower edge portion of the engagement portion 92 is connected to the mount portion 91.

The contact 100 is formed, for example, by processing a thin plate composed of a copper alloy having a spring elasticity such as phosphor bronze, beryllium copper, or titanium copper, or a Corson copper alloy into the shape illustrated in FIG. 16 by using a progressive die (stamping). The contact 100 is formed by punching and then bending in the thickness direction. The surface of the contact 100 is undercoated with nickel plating and then plated with gold, tin, or the like.

The multiple pairs of contacts 100 are arranged in the right-left direction. The contacts 100 of a pair have the same shape. The first contact 100a and the second contact 100b have the same shape.

The contact 100 includes a mount portion 101 extending outward in the front-rear direction in a straight line. The contact 100 includes a connection portion 102 connected to the mount portion 101. The connection portion 102 has such a shape that two inverted L's are connected. More specifically, the connection portion 102 extends upward in a straight line from the mount portion 101, is then bent at approximately 90°, and extends in the front-rear direction. The connection portion 102 is bent at approximately 90° again, extends upward in a straight line, is bent at approximately 90°, and extends in the front-rear direction.

The contact 100 includes an engagement portion 103 extending upward in a straight line from the end portion of the connection portion 102. The contact 100 includes an elastically deformable elastic contact portion 104 extending upward from the engagement portion 103 while curving. The contact 100 includes a contact portion 105 located on the inner side of the elastic contact portion 104 in the front-rear direction.

The shield member 110 is formed by processing a thin plate of a certain metal material into the shape illustrated in FIG. 16 by using a progressive die (stamping). The processing method of the shield member 110 includes punching and then bending in the thickness direction. The shield member 110 has a shape along continuous three sides of a rectangle in top view. The multiple shield members 110 are arranged in the right-left direction. The shield members 110 are attached to the insulator 80.

The shield members 110 of a pair located at the same right-left position are symmetric in the front-rear direction. The pair of shield members 110 is line-symmetric with respect to the vertical axis passing through the center of the pair of shield members 110. The shield members 60 in each pair arranged in the same front-rear position have the same shape and arrangement in the right-left direction.

The shield member 110 includes a pair of first shield portions 111 extending in planes in the front-rear direction. The shield member 110 includes a second shield portion 112 extending in a plane in the right-left direction and connecting, in the right-left direction, the first shield portions 111 of the pair away from each other in the front-rear direction. The shield member 110 includes elastically deformable elastic contact portions 113 extending upward, while bending, from upper end portions of end portions in the front-rear direction of the first shield portions 111. The shield member 110 includes mount portions 114 extending outward in the front-rear direction in straight lines from lower end portions of end portions in the front-rear direction of the first shield portions 111.

Each shield member 110 is located between a pair of contacts 100 and the other pairs of contacts 100. Each shield member 110 is located between the multiple contacts 100. Each shield member 110 surrounds a pair of contacts 100 from both sides in the right-left direction and the inner side in the front-rear direction.

As can be understood from FIG. 16 and other figures, the metal members 90 are attached to the metal-member attachment grooves 83 of the insulator 80. For example, the engagement portions 92 of the metal members 90 are engaged with the metal-member attachment grooves 83 of the insulator 80. The metal members 90 are located at both the right and left end portions of the insulator 80.

The multiple contacts 100 are each attached to one of the multiple contact attachment grooves 84 of the insulator 80. More specifically, the multiple first contacts 100a are each attached to one of the multiple first-contact attachment grooves 84a of the insulator 80. The multiple second contacts 100b are each attached to one of the multiple second-contact attachment grooves 84b of the insulator 80.

The engagement portion 103 of each contact 100 is engaged with a corresponding contact attachment groove 84 of the insulator 80. In this state, the elastic contact portion 104 of the contact 100 is elastically deformable in the front-rear direction inside the contact attachment groove 84. The contact portion 105 of the elastic contact portion 104 is exposed from the contact attachment groove 84 and located in the mating recess 81.

Approximately the entire first and second shield portions 111 and 112 of each shield member 110 are engaged with one of the attachment grooves 85 located in the insulator 80. The shield members 110 are attached to the insulator 80.

The connection target 70 having a structure as described above is mounted on, for example, a circuit formation surface on a mounting surface of a circuit board CB2. More specifically, the mount portions 91 of the metal members 90 are placed on solder paste applied to pads on the circuit board CB2. The mount portions 101 of the contacts 100 are placed on solder paste applied to pads on the circuit board CB2. The mount portions 114 of the shield members 110 are placed on solder paste applied to pads on the circuit board CB2.

The pieces of solder paste are heated and melted in a reflow oven or the like, so that the mount portions 91, the mount portions 101, and the mount portions 114 are soldered to the pads mentioned above. Thus, mounting the connection target 70 onto the circuit board CB2 is completed. In addition to the connection target 70, for example, other electronic components including a camera module and a sensor are mounted on the circuit formation surface of the circuit board CB2.

FIG. 17 is a cross-sectional view taken along arrow line XVII-XVII in FIG. 1. Mainly the operation of the connector 10 having a floating structure will be described mainly with reference to FIG. 17.

The first insulator 20 is fixed to the circuit board CB1 by the mount portions 52 of the contacts 50 being soldered to the circuit board CB1. The second shield members 60b attached to the first insulator 20 are also fixed to the circuit board CB1. Since the contacts 50 are configured to be elastically deformed, the second insulator 30 is movable relative to the first insulator 20 fixed to the circuit board CB1. The first shield members 60a attached to the second insulator 30 are also movable relative to the first insulator 20 along with the movement of the second insulator 30. For example, the first shield portions 61a are movable relative to the first insulator 20 along with the movement of the second insulator 30. In this state, the connection portions 67, connecting the first shield members 60a and the second shield members 60b in the shield members 60, are elastically deformed.

As can be understood from FIG. 4, the second restriction portions 23b of the first insulator 20 are configured to restrict excessive movement of the second insulator 30 in the front-rear direction relative to the first insulator 20. For example, when the second insulator 30 seeks to move significantly in the front-rear direction beyond the design value along with elastic deformation of the contacts 50, the corresponding second restriction receiving portions 36b of the second insulator 30 come into contact with the corresponding second restriction portions 23b. Hence, the second insulator 30 does not move any further outward in the front-rear direction.

The first restriction portions 23a of the first insulator 20 are configured to restrict excessive movement of the second insulator 30 in the right-left direction relative to the first insulator 20. For example, when the second insulator 30 seeks to move significantly in the right-left direction beyond the design value along with elastic deformation of the contacts 50, the corresponding first restriction receiving portion 36a of the second insulator 30 comes into contact with the corresponding first restriction portion 23a. Hence, the second insulator 30 does not move any further outward in the right-left direction.

In the state in which the orientation of the connection target 70 in the up-down direction is inverted relative to the connector 10 having a floating structure as described above, the connector 10 and the connection target 70 are made to face each other in the up-down direction with the front-rear positions and the right-left positions of them approximately aligned. Then, the connection target 70 is moved downward. In this process, even if the positions relative to each other differ, for example, in the front-rear direction and the right-left direction to some extent, the floating structure of the connector 10 enables the second insulator 30 to move relative to the first insulator 20.

More specifically, the mating protrusion 32 of the second insulator 30 is guided into the mating recess 81 of the insulator 80. When the connection target 70 is further moved downward, the mating protrusion 32 of the second insulator 30 and the mating recess 81 of the insulator 80 are mated with each other. In this state, the mating recesses 33 of the second insulator 30 are mated with the mating protrusions 82 of the insulator 80.

As illustrated in FIG. 17, in the mated state in which the second insulator 30 of the connector 10 and the insulator 80 of the connection target 70 are mated with each other, the contacts 50 of the connector 10 are in contact with the contacts 100 of the connection target 70. More specifically, the contact portions 57 of the contacts 50 are in contact with the contact portions 105 of the contacts 100. The contact portions 57a of the first contacts 50a are in contact with the contact portions 105 of the first contacts 100a. The contact portions 57b of the second contacts 50b are in contact with the contact portions 105 of the second contacts 100b. In this state, the elastic contact portions 104 of the contacts 100 are slightly elastically deformed in the front-rear direction and elastically displaced in the contact attachment grooves 84 in the front-rear direction.

With this operation, the connector 10 is completely connected to the connection target 70. In this state, the circuit board CB1 is electrically connected to the circuit board CB2 with the contacts 50 and contacts 100 interposed therebetween.

In the mated state in which the connector 10 and the connection target 70 are mated with each other, the first shield members 60a are in contact with the shield members 110. More specifically, the elastic contact portions 113 of the shield members 110 are in contact with the right and left inner surfaces of the first shield portions 61a of the first shield members 60a.

In the following, attention is mainly focused on the connector 10, and its advantageous effects will be described. However, the same or similar description can be applied to the connector module 1 and the electronic device.

In an embodiment, the connector 10 as described above makes adjustment of the characteristic impedance easy while maintaining the movability of the movable insulator. The connector 10 provides favorable transmission characteristics in signal transmission while maintaining the movability of the movable insulator.

In one contact 50 of a pair of contacts 50 in the connector 10, a first surface of at least part of the elastic portion 54 faces a first surface of the elastic portion 54 of the other contact 50. The contacts 50 of a pair face each other at their corresponding first surfaces orthogonal to the thickness direction of the contacts 50 and having larger areas. This provides effects the same as or similar to the effects of a capacitor, between the contacts 50 of the pair. When the electrostatic capacity is defined as C, the characteristic impedance Z in this state is dependent on the electrostatic capacity C. For example, the characteristic impedance Z is inversely proportional to the square root of the electrostatic capacity C or inversely proportional to the electrostatic capacity C.

Hence, when the facing surface area of the capacitor is larger to increase the electrostatic capacity C, the characteristic impedance is lower. The connector 10 enables adjustment of the characteristic impedance, keeping a reasonable distance in design between the contacts 50 of a pair in the arrangement direction, compared with the case in which the elastic portions 54 of a pair face each other at their corresponding second surfaces. This enables adjustment of the characteristic impedance while keeping the thickness of the elastic portion 54 of the contact 50 and the width of the first surface in the direction orthogonal to the extending direction in the elastic portion 54. Since the thickness of the elastic portion 54 of the contact 50 and the width of the first surface in the direction orthogonal to the extending direction in the elastic portion 54 can be kept in the connector 10, a decrease in the movability of the second insulator 30 can be reduced, and an increase in size of the connector 10 can also be reduced.

Conversely, the characteristic impedance can be easily adjusted in the connector 10 by changing, in a desired manner, the width of the first surfaces in the direction orthogonal to the extending direction in the elastic portion 54 of the contact 50. Hence, the degree of freedom in design can be higher in the connector 10 than in the case in which the elastic portions 54 of a pair face each other at their corresponding second surfaces.

Thus, in the connector 10, matching the value of the characteristic impedance to an ideal value is easy by using the configuration of the capacitor in the elastic portions 54 of the contacts 50. The connector 10 can improve transmission characteristics in signal transmission while maintaining the movability of the second insulator 30. The connector 10 makes it possible to achieve both adjustment of the characteristic impedance necessary for high-speed transmission and the movability of the movable insulator while improving the degree of freedom in the design.

In one contact 50 of a pair of contacts 50 in the connector 10, at least one of the first connection portion 53 or the second connection portion 55 includes a first portion. This enables the elastic portion 54 of the one contact 50 to be closer to the elastic portion 54 of the other contact 50 in the arrangement direction of the multiple pairs of contacts 50. This further increases the electrostatic capacity C of the capacitor formed by the pair of elastic portions 54. This further reduces the characteristic impedance. Thus, the aforementioned effect that both adjustment of the characteristic impedance and the movability of the movable insulator can be achieved while the degree of freedom in designing the contacts 50 is improved is more significant.

At least parts of the elastic portions 54 of a pair face each other in the arrangement direction of the multiple pairs of contacts 50 at their corresponding first surfaces. This makes it possible to achieve space saving in the elastic portions 54 in the arrangement direction and also makes more significant the aforementioned effects related to achieving both adjustment of the characteristic impedance and the movability of the movable insulator in the contacts 50.

In one contact 50, at least one of the first connection portion 53 or the second connection portion 55 includes a second portion. This makes it less likely for the stress and the like when the elastic portion 54 is elastically deformed to affect the constituent portions located in the region from the corresponding base portion to the end portion of the contact 50 in the connector 10. For example, the stress generated in the mount portion 52 when the elastic portion 54 is elastically deformed can be reduced in the connector 10. Hence, the connector 10 can reduce damage in the mount portion 52 such as a solder crack and can improve the product reliability.

The first base portions 51 of a pair face each other in the arrangement direction of the multiple pairs of contacts 50 at their corresponding second surfaces. This enables a design of the connector 10 in which the first held portion included in the first base portion 51 is located between the elastic portion 54 and the mount portion 52, making it possible to further reduce the stress generated in the mount portion 52 when the elastic portion 54 is elastically deformed. Thus the connector 10 can further reduce damage in the mount portions 52 such as a solder crack and further improve the product reliability. In addition, since stubs in the engagement portions can be reduced in the connector 10, the occurrence of branching or the like of the transmission signal at the stubs can be reduced. Thus, the connector 10 can improve the transmission characteristics in signal transmission.

The second base portions 56 of a pair face each other in the arrangement direction of the multiple pairs of contacts 50 at their corresponding second surfaces. This enables a design of the connector 10 in which the second held portion included in the second base portion 56 is located between the elastic portion 54 and the contact portion 57, making it possible to further reduce the stress generated in the contact portion 57 when the elastic portion 54 is elastically deformed. Thus, the reliability of contact of the contact portions 57 with the contacts 100 of the connection target 70 is high in the connector 10, making it possible to improve the product reliability. In addition, since stubs in the engagement portions can be reduced in the connector 10, the occurrence of branching or the like of the transmission signal at the stubs can be reduced. Thus, the connector 10 can improve the transmission characteristics in signal transmission.

Since the distance L0 of the elastic portions 54 of a pair is shorter than at least one of the distance L1 or the distance L2 in the connector 10, the characteristic impedance of the elastic portions 54 which tends to be high can be easily reduced. The connector 10 more significantly provides the aforementioned effect that both adjustment of the characteristic impedance necessary for high-speed transmission and the movability of the movable insulator can be achieved while the degree of freedom in the design is improved.

In the connector 10, when viewed in the arrangement direction of the multiple pairs of contacts 50, the width over which the elastic portions 54 of a pair overlap each other is larger than at least one of the width over which the first base portions 51 of the pair overlap each other or the width over which the second base portions 56 of the pair overlap each other. Thus, in the connector 10, the facing surface area of the capacitor formed by the pair of elastic portions 54 can be large, further increasing the electrostatic capacity C. This makes more significant the aforementioned effect that both adjustment of the characteristic impedance and the movability of the movable insulator can be achieved while the degree of freedom in designing the contacts 50 is improved.

Since the contacts 50 of a pair are located to be line-symmetric in the arrangement direction of the multiple pairs of contacts 50 in the connector 10, the symmetry between the contacts 50 of a pair can be improved, which can improve the differential transmission characteristics. In a pair of conventional contacts having the same shape, the distance between the elastic portions is determined by the pitch distance of the contacts of the pair, in other words, the distance between the mount portions of the pair in the arrangement direction. Unlike such conventional contacts, the contacts 50 of a pair have different shapes in the connector 10, Hence, the distance in the right-left direction of the first surfaces of the pair facing each other can be changed in the elastic portions 54 of the pair without changing the pitch distance.

The pair of first cutout portions 58 provided in a pair of contacts 50 makes it easy to bend the contacts 50 in the connector 10. In manufacturing the contacts 50, forming a bent structure at the first connection portion 53 is easy. The pair of second cutout portions 59 provided in a pair of contacts 50 makes it easy to bend the contacts 50 in the connector 10. In manufacturing the contacts 50, forming a bent structure at the second connection portion 55 is easy.

Since the connector 10 includes the shield members 60 each located between a pair of contacts 50 and the other pairs of contacts 50, the noise shielding effect can be improved. For example, electromagnetic wave noises entering the multiple pairs of contacts 50 from the outside and emission of electromagnetic wave noises from the multiple pairs of contacts 50 to the outside are effectively reduced. For example, the cross talk and the like between the multiple contacts 50 are effectively reduced. Thus, also for high-speed transmission, the connector 10 provides favorable transmission characteristics for radio-frequency signals. The effects mentioned above can also be applied to the case in which each shield member 60 shields a contact 50 from the other contacts 50, and a variation described later in which each shield member 60 shields a set of contacts 50 from the other sets, each set including three or more contacts 50.

In an embodiment, the connector 10 as described above provides favorable transmission characteristics in signal transmission even though it has a floating structure. Since the first shield member 60a includes the first shield portions 61a, the connector 10 provides effects related to improvement in the noise shielding effect mentioned above in the longitudinal direction of the connector 10.

In the connector 10, since the first shield portions 61a are movable relative to the first insulator 20 along with the movement of the second insulator 30, the first shield portions 61a can move together with the portions of the contacts 50 located on the second insulator 30 side. Thus, contact between the first shield portions 61a and the contacts 50 is reduced also in the floating operation.

Since the first shield member 60a includes the second shield portion 62a, the connector 10 provides effects related to improvement in the noise shielding effect mentioned above in the lateral direction of the connector 10.

Since the connector 10 includes not only the first shield member 60a but also the second shield member 60b, the connector 10 more significantly provides effects related to improvement in the noise shielding effect mentioned above.

Since the second shield member 60b includes the third shield portions 61b, the connector 10 more significantly provides effects related to improvement in the noise shielding effect mentioned above in the longitudinal direction of the connector 10.

Since the second shield member 60b includes the fourth shield portion 62b, the connector 10 more significantly provides effects related to improvement in the noise shielding effect mentioned above in the lateral direction of the connector 10.

Since the first shield member 60a and the second shield member 60b are connected to each other in the connector 10, the first shield member 60a and the second shield member 60b can be formed as one shield member 60, which can further improve the noise shielding effect mentioned above.

Since the multiple first shield members 60a are arranged in at least one of the first direction or the second direction, the connector 10 can further improve the noise shielding effect mentioned above in whole.

Since the multiple second shield members 60b are arranged in at least one of the first direction or the second direction, the connector 10 can further improve the noise shielding effect mentioned above in whole.

Since the distance between each second base portion 56 and the first shield member 60a is constant when the second insulator 30 is moved, the disturbance of the characteristic impedance in the second base portion 56 of the contact 50 can be reduced in the connector 10. Hence, the connector 10 provides favorable transmission characteristics in signal transmission even though it has a floating structure.

The distance between the elastic portion 54 of each contact 50 and the first shield member 60a is larger than the distance between the second base portion 56 and the first shield member 60a. Hence, when the distance between the elastic portion 54 and the first shield member 60a is changed along with elastic deformation of the elastic portion 54, the change in the characteristic impedance can be reduced in the connector 10.

The distance between the elastic portion 54 of each contact 50 and the second shield member 60b is longer than the distance between the first base portion 51 and the second shield member 60b. Hence, when the distance between the elastic portion 54 and the second shield member 60b is changed along with elastic deformation of the elastic portion 54, the change in the characteristic impedance can be reduced in the connector 10.

Since the distance between each first base portion 51 and the second shield member 60b is constant when the second insulator 30 is moved, the disturbance of the characteristic impedance in the first base portion 51 of the contact 50 can be reduced in the connector 10. Hence, the connector 10 provides favorable transmission characteristics in signal transmission even though it has a floating structure.

Since each first shield member 60a is in contact with a corresponding shield member 110 in the mated state in the connector module 1, the first shield member 60a and the shield member 110 can be regarded as one shield member in the connector module 1, which can further improve the noise shielding effect mentioned above.

Since the contact 50 includes a metal material having a small elastic modulus, the connector 10 can achieve a necessary range of movement of the second insulator 30 even when the force exerted on the second insulator 30 is small. The second insulator 30 can move smoothly relative to the first insulator 20. This enables the connector 10 to easily absorb the positional deviation when being mated with the connection target 70.

The connector 10 absorbs vibration caused by some external factor by using elastic deformation of the contacts 50. This reduces the possibility that a strong force can be exerted on the mount portions 52 of the contacts 50. Hence, damage in the connection portions with the circuit board CB1 is reduced. Solder cracks at the connection portions between the circuit board CB1 and the mount portions 52 can be reduced. Hence, the reliability of connection when the connector 10 is connected to the connection target 70 can be improved.

Since the metal members 40 are press-fitted into the first insulator 20, and the mount portions 41 are soldered to the circuit board CB1, the metal members 40 enables the first insulator 20 to be stably fixed to the circuit board CB1. The metal members 40 improve the strength of mounting the first insulator 20 to the circuit board CB1.

Those skilled in the art will clearly understand that the present disclosure can be implemented in other appropriate embodiments other than the aforementioned embodiment without departing from the spirit or the essential features. Hence, the above description is exemplary and does not limit the present disclosure. The scope of the disclosure is defined not by the above description but by the appended claims. Of various changes, several changes within the scope of the equivalents of the claims are included in the scope of the disclosure.

For example, the shape, size, position, orientation of each aforementioned constituent portion, and the number of constituent portions are not limited to the above description and the illustration in the drawings. The shape, size, position, orientation of each constituent portion, and the number of constituent portions may be configured in any way that enables the function of the constituent portion.

The aforementioned methods of assembling the connector 10 and the connection target 70 are not limited to the above description. The connector 10 and the connection target 70 may be assembled by any method that enables them to provide their functions.

For example, at least one item selected from the group of the metal members 40, the contacts 50, and the shield members 60 may be integrated with the first insulator 20 by insert molding instead of press fitting. For example, at least one item selected from the contacts 50 and the shield members 60 may be integrated with the second insulator 30 by insert molding instead of press fitting. For example, at least one item selected from the group of the metal members 90, the contacts 100, and the shield members 110 may be integrated with the insulator 80 by insert molding instead of press fitting.

Although in the description of the aforementioned embodiment, the entire elastic portions 54 of a pair face each other at their corresponding first surfaces, the present disclosure is not limited to this configuration. Parts of the elastic portions 54 of a pair may face each other at their corresponding first surfaces. The remaining parts of the elastic portions 54 of the pair may face each other at their corresponding second surfaces, or may face each other at a first surface of one elastic portion 54 and a second surface of the other elastic portion 54.

Although in the description of the aforementioned embodiment, the first connection portion 53a and the second connection portion 55a include the first portion 53a1 and the first portion 55al, respectively, the present disclosure is not limited to this configuration. Only one of the first connection portion 53a and the second connection portion 55a may include a first portion, or a configuration in which none of them includes a first portion is also possible.

Although in the description of the aforementioned embodiment, the first connection portion 53b and the second connection portion 55b include the first portion 53b1 and the first portion 55b1, respectively, the present disclosure is not limited to this configuration. Only one of the first connection portion 53b and the second connection portion 55b may include a first portion, or a configuration in which none of them includes a first portion is also possible.

Although in the description of the aforementioned embodiment, the orientation of the rolled surface is different in each constituent portion of the contact 50, the present disclosure is not limited to this configuration. In the contact 50, the rolled surface of each constituent portion may be oriented in the same specified direction, for example, the front-rear direction.

Although in the description of the aforementioned embodiment, the elastic portions 54 of a pair face each other at their corresponding first surfaces in the arrangement direction of the multiple pairs of contacts 50, the present disclosure is not limited to this configuration. The elastic portions 54 of a pair may face each other at their corresponding first surfaces in any direction. For example, in the case of contacts 50 according to a variation of the aforementioned configuration in which the rolled surface of each constituent portion face the same direction, as a surface facing the front-rear direction, the elastic portions 54 of a pair may face each other at their corresponding first surfaces in the front-rear direction.

In the variation mentioned above, the distance in the front-rear direction of the paired first surfaces facing each other in the elastic portions 54 of a pair may be longer than at least one of the distance of the first base portions 51 of the pair in the front-rear direction or the distance of the second base portions 56 of the pair in the front-rear direction. In a pair of conventional contacts having the same shape, the distance between the elastic portions is determined by the pitch distance of the contacts of a pair, in other words, the distance between the mount portions of the pair in the arrangement direction. Unlike such conventional contacts, the contacts 50 of a pair have different shapes in the connector 10. Hence, the distance in the front-rear direction of the first surfaces of the pair facing each other can be changed in the elastic portions 54 of the pair without changing the pitch distance. In the variation mentioned above, outer side portions of the elastic portions 54 in the right-left direction may be cut off so that the elastic portions 54 of the contacts 50 can be easily elastically deformed. Thus, the widths in the right-left direction of the elastic portions 54 of the pair facing each other in the front-rear direction may be small.

In the variation mentioned above, the first plane of the first connection portion 53 connecting the first base portion 51 and the elastic portion 54 may be in the same plane as the first plane of the elastic portion 54. The first connection portion 53 may include a portion extending toward the other contact 50 in the arrangement direction of the multiple pairs of contacts 50 to make the elastic portion 54 closer to the elastic portion 54 of the other contact 50 in the arrangement direction. The first connection portion 53 may further include a portion bent from the portion mentioned above toward the elastic portion 54 located in the mating direction. More specifically, the first connection portion 53 may further include a portion bent from the portion mentioned above at an angle of approximately 90° toward the elastic portion 54 located in the mating direction.

In the variation mentioned above, the first plane of the second connection portion 55 connecting the second base portion 56 and the elastic portion 54 may be in the same plane as the first plane of the elastic portion 54. The second connection portion 55 may include a portion extending toward the other contact 50 in the arrangement direction of the multiple pairs of contacts 50 to make the elastic portion 54 closer to the elastic portion 54 of the other contact 50 in the arrangement direction. The second connection portion 55 may further include a portion bent from the portion mentioned above toward the elastic portion 54 located in the mating direction. More specifically, the second connection portion 55 may further include a portion bent from the portion mentioned above at an angle of approximately 90° toward the elastic portion 54 located in the mating direction.

Although in the description of the aforementioned embodiment, the first connection portion 53a and the second connection portion 55a include the second portion 53a2 and the second portion 55a2, respectively, the present disclosure is not limited to this configuration. Only one of the first connection portion 53a and the second connection portion 55a may include a second portion, or a configuration in which none of them includes a second portion is also possible.

Although in the description of the aforementioned embodiment, the first connection portion 53b and the second connection portion 55b include the second portion 53b2 and the second portion 55b2, respectively, the present disclosure is not limited to this configuration. Only one of the first connection portion 53b and the second connection portion 55b may include a second portion, or a configuration in which none of them includes a second portion is also possible.

Although in the description of the aforementioned embodiment, the first base portions 51 of a pair face each other in the arrangement direction of the multiple pairs of contacts 50 at their corresponding second surfaces parallel to the thickness direction of the contacts 50, the present disclosure is not limited to this configuration. The first base portions 51 of a pair may face each other at their corresponding first surfaces, or may face each other at a first surface of one first base portion 51 and a second surface of the other first base portion 51. The first base portions 51 of a pair may face each other in any direction.

Although in the description of the aforementioned embodiment, the second base portions 56 of a pair face each other in the arrangement direction of the multiple pairs of contacts 50 at their corresponding second surfaces parallel to the thickness direction of the contacts 50, the present disclosure is not limited to this configuration. The second base portions 56 of a pair may face each other at their corresponding first surfaces, or may face each other at a first surface of one second base portion 56 and a second surface of the other second base portion 56. The second base portions 56 of a pair may face each other in any direction.

Although in the description of the aforementioned embodiment, the distance L0 between the paired center lines of the elastic portions 54 of a pair is shorter than the distance L1 between the paired center lines of the first base portions 51 of the pair and the distance L2 of the paired center lines of the second base portions 56 of the pair in the arrangement direction of the multiple pairs of contacts 50, the present disclosure is not limited to this configuration. The distance L0 may be shorter than one of the distance L1 and the distance L2.

Although in the description of the aforementioned embodiment, when viewed in the arrangement direction of the multiple pairs of contacts 50, the width over which the elastic portions 54 of a pair overlap each other is larger than the width over which the first base portions 51 of the pair overlap each other and the width over which the second base portions 56 of the pair overlap each other in the direction orthogonal to the extending direction of the contacts 50, the present disclosure is not limited to this configuration. The width over which the elastic portions 54 of a pair overlap each other may be larger than one of the width over which the first base portions 51 of the pair overlap each other and the width over which the second base portions 56 of the pair overlap each other.

Although in the description of the aforementioned embodiment, the contacts 50 of a pair are located to be line-symmetric in the arrangement direction of the multiple pairs of contacts 50, the present disclosure is not limited to this configuration. The contacts 50 of a pair may be located to be non-symmetric in the arrangement direction of the multiple pairs of contacts 50.

Although in the aforementioned embodiment, neither the first insulator 20 nor the second insulator 30 is interposed between the contacts 50 of a pair at the first connection portions 53 and the second connection portions 55, the present disclosure is not limited to this configuration. Part of an insulator may be interposed between the contacts 50 of a pair at either the first connection portions 53 or the second connection portions 55, or both. For example, part of the first insulator 20 may be interposed between the first connection portions 53 of the contacts 50 of a pair. For example, part of the second insulator 30 may be interposed between the second connection portions 55 of the contacts 50 of a pair.

The present disclosure is not limited to configurations as described above in which part of an insulator is interposed. Another insulator such as an insulation film may be interposed between the contacts 50 of a pair at either the first connection portions 53 or the second connection portions 55, or both. At either the first connection portions 53 or the second connection portions 55, or both, an insulator such as a resin may be attached to a surface of at least one of the contacts 50 of a pair. In addition, the connector 10 may include an additional shield member. This shield member covers all the mating recesses 33 located in the second insulator 30 from above so as to hide the pairs of elastic portions 54 or covers the gap portions of the first shield members 60a on the outer sides in the front-rear direction, from the outer sides in the front-rear direction.

The above configuration can reduce short circuits caused by the elastic portions 54 of a pair, the distance of which is small in the arrangement direction of the multiple pairs of contacts 50, coming into contact with each other or a foreign object entering between the elastic portions 54 of a pair, in the connector 10.

Although in the description of the aforementioned embodiment, the connector 10 further includes the shield members 60 each located between a pair of contacts 50 and the other pairs of contacts 50, the present disclosure is not limited to this configuration. A configuration in which the connector 10 does not include such shield members 60 is also possible.

Although in the description of the aforementioned embodiment, the shield member 60 has a shape along continuous three sides of a rectangle in top view, the present disclosure is not limited to this configuration. The shield member 60 may have a complete rectangular shape in top view or may have any other shape such as a circular shape, a semicircular shape, a U shape, or a C shape in top view.

Although in the description of the aforementioned embodiment, each surface of the shield member 60 is flat, the present disclosure is not limited to this configuration. Each surface of the shield member 60 may be a curved surface. Each surface of the shield member 60 may include a cutout or a hole at a portion of it as long as each surface of the shield member 60 can maintain the aforementioned effects related to shielding of the shield member 60.

Although in the description of the aforementioned embodiment, the shield member 60 shields a pair of contacts 50 from the other pairs of contacts 50, the present disclosure is not limited to this configuration. The shield member 60 may shield one contact 50 from the other contacts 50 or may shield one set of contacts 50 from the other sets, each set including three or more contacts.

Although in the description of the aforementioned embodiment, the shield members 60 are attached to both the first insulator 20 and the second insulator 30, the present disclosure is not limited to this configuration. The shield member 60 may be attached to only one of the first insulator 20 and the second insulator 30 or may be attached to only the circuit board CB1 without being attached to either the first insulator 20 or the second insulator 30.

Although in the description of the aforementioned embodiment, the first shield member 60a includes the pair of first shield portions 61a aligned in the right-left direction, the present disclosure is not limited to this configuration. A first shield portion 61a may be located on only one side in the right-left direction in the first shield member 60a.

Although in the description of the aforementioned embodiment, the first shield portions 61a are movable relative to the first insulator 20 along with the movement of the second insulator 30, the present disclosure is not limited to this configuration. The first shield member 60a including the first shield portions 61a may be stationary.

Although in the description of the aforementioned embodiment, the first shield member 60a includes the second shield portion 62a, the present disclosure is not limited to this configuration. A configuration without a second shield portion 62a in the first shield member 60a is also possible.

Although in the description of the aforementioned embodiment, the connector 10 includes the second shield member 60b, the present disclosure is not limited to this configuration. A configuration in which the connector 10 does not include the second shield member 60b and only includes the first shield member 60a is also possible.

Although in the description of the aforementioned embodiment, the second shield member 60b includes the third shield portions 61b, the present disclosure is not limited to this configuration. A configuration without third shield portions 61b in the second shield member 60b is also possible.

Although in the description of the aforementioned embodiment, the second shield member 60b includes the pair of third shield portions 61b aligned in the right-left direction, the present disclosure is not limited to this configuration. A third shield portion 61b may be located on only one side in the right-left direction in the second shield member 60b.

Although in the description of the aforementioned embodiment, the second shield member 60b includes the fourth shield portion 62b, the present disclosure is not limited to this configuration. A configuration without a fourth shield portion 62b in the second shield member 60b is also possible.

Although in the description of the aforementioned embodiment, the first shield member 60a and the second shield member 60b are connected to each other, the present disclosure is not limited to this configuration. A configuration in which the first shield member 60a and the second shield member 60b are not connected to each other is also possible.

Although in the description of the aforementioned embodiment, the multiple second shield members 60b are arranged in the first direction and the second direction, the present disclosure is not limited to this configuration. Multiple second shield members 60b may be arranged in only one of the first direction and the second direction, or a configuration in which multiple second shield members 60b are not arranged in either of the directions is also possible.

Although in the aforementioned embodiment, the adjacent second shield members 60b of a pair are not connected to each other, the present disclosure is not limited to this configuration. The adjacent second shield members 60b of a pair may be connected to each other. For example, the adjacent second shield members 60b of a pair may be connected to each other by using a constituent portion the same as or similar to the connection portion 67 connecting the first shield member 60a and the second shield member 60b.

When the adjacent second shield members 60b of a pair are connected to each other in the connector 10, the adjacent second shield members 60b of the pair can be formed as one shield member 60, which further improves the noise shielding effect mentioned above.

Although in the description of the aforementioned embodiment, the second shield members 60b of a pair adjacent to each other in the first direction are in contact with each other with the surface contact between the fourth shield portions 62b of the pair interposed therebetween, the present disclosure is not limited to this configuration. The adjacent second shield members 60b of a pair may have, instead of or in addition to such surface contact, a contact structure in which the adjacent second shield members 60b slide on each other at the first spring portion 65b or the second spring portion 66b.

Although in the description of the aforementioned embodiment, the distance between each first base portion 51 and the second shield member 60b is constant when the second insulator 30 is moved relative to the first insulator 20, the present disclosure is not limited to this configuration. The distance between each first base portion 51 and the second shield member 60b may change when the second insulator 30 is moved relative to the first insulator 20.

In such a case, since the contacts 50 of a pair are close to each other in the arrangement direction, the characteristic impedance is not dependent on the second shield member 60b and can be adjusted between the contacts 50 of a pair. Hence, unlike the case in which the contacts 50 of a pair are far away from each other in the arrangement direction, keeping the distance between each contact 50 and the second shield member 60b constant so as not to disturb the characteristic impedance is not essential. In the aforementioned embodiment, the connector 10 need not include the second shield members 60b from the view point of adjustment of the characteristic impedance.

Although in the description of the aforementioned embodiment, the multiple first shield members 60a are arranged in the first direction and the second direction, the present disclosure is not limited to this configuration. Multiple first shield members 60a may be arranged in only one of the first direction and the second direction, or a configuration in which multiple first shield members 60a are not arranged in either of the directions is also possible.

Although in the aforementioned embodiment, the adjacent first shield members 60a of a pair are not connected to each other, the present disclosure is not limited to this configuration. The adjacent first shield members 60a of a pair may be connected to each other. For example, the adjacent first shield members 60a of a pair may be connected to each other by using a constituent portion the same as or similar to the connection portion 67 connecting the first shield member 60a and the second shield member 60b. For example, the adjacent first shield members 60a of a pair may include a contact structure in which the adjacent first shield members 60a slide on each other by using a constituent portion the same as or similar to the first spring portion 65b or the second spring portion 66b.

FIG. 18 is a perspective view of a set of a pair of contacts 50 and a shield member 60 of a connector 10 according to a variation, illustrating their outer appearances from above. Although in the description of the aforementioned embodiment, the connection portion 67 extends from a lower edge portion of the second shield portion 62a, is bent in a J shape, is then bent in an inverted J shape, and is connected to an upper edge portion of the fourth shield portion 62b as illustrated in FIG. 12 and other figures, the present disclosure is not limited to this configuration.

As illustrated in FIG. 18, a connection portion 67 may have a contact spring structure. The connection portion 67 may extend obliquely upward from an upper edge portion of the fourth shield portion 62b toward the second shield portion 62a. The connection portion 67 having a spring elasticity may be in contact with a surface of the second shield portion 62a. When the first shield member 60a is moved relative to the first insulator 20 along with the movement of the second insulator 30, the connection portion 67 keeps the contact with the surface of the second shield portion 62a by using the contact spring structure. Thus, the connection portion 67 keeps the connection between the first shield member 60a and the second shield member 60b.

When the adjacent first shield members 60a of a pair are connected to each other in the connector 10, the adjacent first shield members 60a of the pair can be formed as one shield member 60, which further improves the noise shielding effect mentioned above.

Although in the description of the aforementioned embodiment, the distance between each second base portion 56 and the first shield member 60a is constant when the second insulator 30 is moved relative to the first insulator 20, the present disclosure is not limited to this configuration. The distance between each second base portion 56 and the first shield member 60a may change when the second insulator 30 is moved relative to the first insulator 20.

Even in such a case, since the contacts 50 of a pair are close to each other in the arrangement direction, the characteristic impedance is not dependent on the first shield member 60a and can be adjusted between the contacts 50 of a pair. Hence, unlike the case in which the contacts 50 of a pair are far away from each other in the arrangement direction, a complicated movable structure of the first shield member 60a for keeping constant the distance between each contact 50 and the first shield member 60a so as not to disturb the characteristic impedance is not essential. In the aforementioned embodiment, the connector 10 need not include the first shield members 60a from the view point of adjustment of the characteristic impedance.

Although in the description of the aforementioned embodiment, the distance between the elastic portion 54 of each contact 50 and the first shield member 60a is longer than the distance between the second base portion 56 and the first shield member 60a, the present disclosure is not limited to this configuration. The distance between the elastic portion 54 of each contact 50 and the first shield member 60a may be shorter than or equal to the distance between the second base portion 56 and the first shield member 60a.

Although in the description of the aforementioned embodiment, the distance between the elastic portion 54 of each contact 50 and the second shield member 60b is longer than the distance between the first base portion 51 and the second shield member 60b, the present disclosure is not limited to this configuration. The distance between the elastic portion 54 of each contact 50 and the second shield member 60b may be shorter than or equal to the distance between the first base portion 51 and the second shield member 60b.

Although in the description of the aforementioned embodiment, the first shield member 60a includes the first held portion 63a extending upward in a straight line from the center of the upper edge portion of the second shield portion 62a, the present disclosure is not limited to this configuration. The first held portion 63a may have any shape and any position in the first shield member 60a.

Although in the description of the aforementioned embodiment, the second shield member 60b includes the second held portions 63b extending upward in straight lines from upper end portions of end portions in the front-rear direction of the third shield portions 61b, the present disclosure is not limited to this configuration. The second held portions 63b may have any shapes and any positions in the second shield member 60b.

Although in the description of the aforementioned embodiment, the first shield members 60a are in contact with the shield members 110 in the mated state in which the connector 10 and the connection target 70 are mated with each other, the present disclosure is not limited to this configuration. In the mated state, the first shield members 60a need not be in contact with the shield members 110.

Although in the description of the aforementioned embodiment, the “first direction” refers to the front-rear direction as an example, the present disclosure is not limited to this configuration. The first direction may be any direction intersecting the mating direction in which the connection target 70 and the second insulator 30 are mated with each other. Although in the description of the aforementioned embodiment, the “second direction” refers to the right-left direction as an example, the present disclosure is not limited to this configuration. The second direction may be any direction intersecting the first direction and the mating direction in which the connection target 70 and the second insulator 30 are mated with each other.

In the above description, the contact 50 includes a metal material having a low elastic modulus, the present disclosure is not limited to this configuration. The contact 50 may include a metal material having any elastic modulus as long as it provides a necessary range of elastic deformation.

In the above description, the connection target 70 is a receptacle connector configured to be connected to the circuit board CB2, the present disclosure is not limited to this configuration. The connection target 70 may be any target object other than connectors. For example, the connection target 70 may be an FPC, a flexible flat cable, a rigid board, or a card edge for any circuit board.

The connector 10 and the connector module 1 as described above are mounted on electronic devices. Examples of the electronic devices include any kind of car-mounted devices such as cameras, radars, drive recorders, and engine control units. Examples of the electronic devices include any kind of car-mounted devices used in car-mounted systems such as car navigation systems, advanced driver assistance systems, and security systems. Examples of the electronic devices include any kind of information devices such as personal computers, smartphones, copy machines, printers, fax machines, and multifunction printers. In addition, examples of the electronic devices include any kind of industrial devices.

Such electronic devices will be able to provide favorable transmission characteristics in signal transmission while maintaining the movability of the movable insulator. Since the favorable floating structure of the connector 10 absorbs a positional deviation between circuit boards, the work efficiency when the electronic device is assembled is improved. The connector 10 makes it easy to manufacture the electronic devices. The connector 10 reduces damage in the connection portions with the circuit board CB1. For example, damage such as a solder crack at the mount portions 52 of the contact 50 is reduced. Hence, defects such as deformation and damage of the contacts 50 are reduced. This improves the product reliability of the electronic device including the connector 10.

The following concepts can be extracted from the present disclosure.

(1)

A connector including:
a frame-shaped first insulator;
a second insulator located at the first insulator, movable relative to the first insulator, and configured to be mated with a connection target;
multiple first contacts attached to the first insulator and the second insulator; and
a first shield member or first shield members, each being located between the multiple first contacts, in which
each first shield member includes a first shield portion located to be parallel to a first direction intersecting a mating direction in which the connection target and the second insulator are mated with each other.
   (2)

The connector according to (1) described above, in which
each first shield member is attached to the second insulator, and
each first shield portion is movable relative to the first insulator along with movement of the second insulator.
   (3)

The connector according to (1) or (2) described above, in which
each first shield member includes a second shield portion located to be parallel to a second direction intersecting the mating direction and the first direction.
   (4)

The connector according to any one of (1) to (3) described above, further including
a second shield member or second shield members attached to the first insulator, each second shield member being located between the multiple first contacts.
   (5)

The connector according to (4) described above, in which
each second shield member includes a third shield portion located to be parallel to the first direction.
   (6)

The connector according to (4) or (5) described above, in which
each second shield member includes a fourth shield portion located to be parallel to a second direction intersecting the mating direction and the first direction.
   (7)

The connector according to any one of (4) to (6) described above, in which
each first shield member is connected to a corresponding one of the second shield member or the second shield members.
   (8)

The connector according to any one of (4) to (7) described above, in which
the second shield members are arranged in at least one of the first direction or a second direction intersecting the mating direction and the first direction.
   (9)

The connector according to (8) described above, in which
adjacent two of the second shield members are connected to each other.
   (10)

The connector according to any one of (4) to (9) described above, in which
each first contact includes a first base portion attached to the first insulator, and
distance between each first base portion and the corresponding second shield member is constant when the second insulator is moved relative to the first insulator.
   (11)

The connector according to any one of (1) to (10) described above, in which
the first shield members are arranged in at least one of the first direction or a second direction intersecting the mating direction and the first direction.
   (12)

The connector according to (11) described above, in which
adjacent two of the first shield members are connected to each other.
   (13)

The connector according to any one of (1) to (12) described above, in which
each first contact includes a second base portion attached to the second insulator, and
distance between each second base portion and the corresponding first shield member is constant when the second insulator is moved relative to the first insulator.
   (14)

The connector according to (13) described above, in which
each first contact includes an elastically deformable elastic portion, and
distance between each elastic portion and the corresponding first shield member is longer than distance between the corresponding second base portion and the first shield member.
   (15)

A connector module including:
the connector according to any one of (1) to (14) described above; and
the connection target, in which
the connection target includes:
   a third insulator configured to be mated with the second insulator;
   multiple second contacts attached to the third insulator; and
   a third shield member or third shield members attached to the third insulator, each third shield member being located between the multiple second contacts, and
in a mated state in which the connector and the connection target are mated with each other, each first shield member is in contact with one of the third shield members.
   (16)

An electronic device including
the connector according to any one of (1) to (14) described above or the connector module according to (15) described above.

### REFERENCE SIGNS

1 connector module
10 connector
20 first insulator
21a opening
21b opening
22 outer peripheral wall
22a lateral wall
22b longitudinal wall
23a first restriction portion
23b second restriction portion
24 metal-member attachment groove
25 contact attachment groove
25a first-contact attachment groove
25b second-contact attachment groove
26 attachment groove
27 partition portion
30 second insulator
31 base portion
32 mating protrusion
33 mating recess
34 contact attachment groove
34a first-contact attachment groove
34b second-contact attachment groove
35 attachment groove
36 restriction receiving portion
36a first restriction receiving portion
36b second restriction receiving portion
40 metal member
41 mount portion
42 engagement portion
43 base portion
50 contact (first contact)
51 first base portion
52 mount portion
53 first connection portion
54 elastic portion
55 second connection portion
56 second base portion
57 contact portion
58 first cutout portion
59 second cutout portion
50a first contact
51a first base portion
51a1 first held portion
52a mount portion
53a first connection portion
53a1 first portion
53a2 second portion
54a elastic portion
54a1 first extension portion
54a2 first curved portion
54a3 second extension portion
54a4 second curved portion
54a5 third extension portion
55a second connection portion
55a1 first portion
55a2 second portion
56a second base portion
56a1 second held portion
57a contact portion
58a first cutout portion
59a second cutout portion
50b second contact
51b first base portion
51b1 first held portion
52b mount portion
53b first connection portion
53b1 first portion
53b2 second portion
54b elastic portion
54b1 first extension portion
54b2 first curved portion
54b3 second extension portion
54b4 second curved portion
54b5 third extension portion
55b second connection portion
55b1 first portion
55b2 second portion
56b second base portion
56b1 second held portion
57b contact portion
58b first cutout portion
59b second cutout portion
60 shield member
60a first shield member
61a first shield portion
62a second shield portion
63a first held portion
60b second shield member
61b third shield portion
62b fourth shield portion
63b second held portion
64b mount portion
65b first spring portion
66b second spring portion
67 connection portion
70 connection target
80 insulator (third insulator)
81 mating recess
82 mating protrusion
83 metal-member attachment groove
84 contact attachment groove
84a first-contact attachment groove
84b second-contact attachment groove
85 attachment groove
90 metal member
91 mount portion
92 engagement portion
100 contact (second contact)
100a first contact
100b second contact
101 mount portion
102 connection portion
103 engagement portion
104 elastic contact portion
105 contact portion
110 shield member (third shield member)
111 first shield portion
112 second shield portion
113 elastic contact portion
114 mount portion
CB1 circuit board
CB2 circuit board
L0 distance
L1 distance
L2 distance

1. A connector comprising:
a frame-shaped first insulator;
a second insulator located at the first insulator, movable relative to the first insulator, and configured to be mated with a connection target;
multiple first contacts attached to the first insulator and the second insulator; and
a first shield member or first shield members, each being located between the multiple first contacts, wherein
each first shield member comprises a first shield portion located to be parallel to a first direction intersecting a mating direction in which the connection target and the second insulator are mated with each other.

2. The connector according to claim 1, wherein
each first shield member is attached to the second insulator, and each first shield portion is movable relative to the first insulator along with movement of the second insulator.

3. The connector according to claim 1, wherein
each first shield member comprises a second shield portion located to be parallel to a second direction intersecting the mating direction and the first direction.

4. The connector according to claim 1, further comprising
a second shield member or second shield members attached to the first insulator, each second shield member being located between the multiple first contacts.

5. The connector according to claim 4, wherein
each second shield member comprises a third shield portion located to be parallel to the first direction.

6. The connector according to claim 4, wherein
each second shield member comprises a fourth shield portion located to be parallel to a second direction intersecting the mating direction and the first direction.

7. The connector according to claim 4, wherein
each first shield member is connected to a corresponding one of the second shield member or the second shield members.

8. The connector according to claim 4, wherein
the second shield members are arranged in at least one of the first direction or a second direction intersecting the mating direction and the first direction.

9. The connector according to claim 8, wherein
adjacent two of the second shield members are connected to each other.

10. The connector according to claim 4, wherein
each first contact comprises a first base portion attached to the first insulator, and
distance between each first base portion and the corresponding second shield member is constant when the second insulator is moved relative to the first insulator.

11. The connector according to claim 1, wherein
the first shield members are arranged in at least one of the first direction or a second direction intersecting the mating direction and the first direction.

12. The connector according to claim 11, wherein
adjacent two of the first shield members are connected to each other.

13. The connector according to claim 1, wherein
each first contact comprises a second base portion attached to the second insulator, and
distance between each second base portion and the corresponding first shield member is constant when the second insulator is moved relative to the first insulator.

14. The connector according to claim 13, wherein
each first contact comprises an elastically deformable elastic portion, and
distance between each elastic portion and the corresponding first shield member is longer than distance between the corresponding second base portion and the first shield member.

15. A connector module comprising:
the connector according to claim 1; and
the connection target, wherein
the connection target comprises:
a third insulator configured to be mated with the second insulator;
multiple second contacts attached to the third insulator; and
a third shield member or third shield members attached to the third insulator, each third shield member being located between the multiple second contacts, and
in a mated state in which the connector and the connection target are mated with each other, each first shield member is in contact with one of the third shield members.

16. An electronic device comprising
the connector according to claim 1.

17. An electronic device comprising
the connector module according to claim 15.
